(19) United States
(12) Patent Application Publication
(10) Pub. No.: US 2013/0297641 A1
(43) Pub. Date: Nov. 7, 2013

(54) CODE STRING SEARCH APPARATUS, SEARCH METHOD, AND PROGRAM

(71) Applicants: Koutaro Shinjo, (US); Kousokuya, Inc., Kanagawa (JP)

(72) Inventors: Toshio Shinjo, Kanagawa (JP); Mitsuhiro Kokubun, Kanagawa (JP)

(21) Appl. No.: 13/926,545

(22) Filed: Jun. 25, 2013

Related U.S. Application Data
(63) Continuation of application No. PCT/JP2011/079375, filed on Dec. 19, 2011.

(30) Foreign Application Priority Data
Dec. 28, 2010 (JP) 2010-293635

(51) Int. Cl. G06F 17/30

(52) U.S. Cl. CPC G06F 17/30386
USPC 707/758

(57) ABSTRACT

To realize a longest prefix match search for code strings, using a coupled-node tree. The configuration of the coupled-node tree is made to be one that is prescribed by the index keys wherein the search target code string is encoded by a combination of a differentiating bit expressing whether a following code exists in the search target code string and bit strings. An initial search is done using an encoded search key that encodes the search key in the same way as the search target code strings while the path traversed during the search is memorized. The longest prefix matching key is retrieved from the search result code string by the initial search and search target code strings accessed by means of the information about the search path that is memorized.

### CROSS-REFERENCE TO RELATED APPLICATIONS

This application is a continuation of PCT/JP2011/079375 filed on Dec. 19, 2011.

PCT/JP2011/079375 is based on and claims the benefit of priority of the prior Japanese Patent Application No. 2010-293635, filed on Dec. 28, 2010, the entire contents of which is incorporated herein by reference. The contents of PCT/JP2011/0079375 are incorporated herein by reference in their entity.

### BACKGROUND OF THE INVENTION

1. Field of the Invention

This invention is related to code string searches that search with a computer for codes or code strings consisting of bit strings in the same way as character string searches that search for character codes or character code strings consisting of bit strings.

2. Description of Related Art

Recently it has become customary to use word processing to create business documents, and by the spread of the internet, the number and size of electronic documents, using character codes consisting of bit strings that can be processed by computers, have grown immensely throughout the world. For this reason, various character string search methods are being developed in order to fetch a necessary document from out of this huge amount of documents using computers.

As an example of these character string search methods, a longest prefix match search that searches variable length character strings (hereinbelow expressed as a longest prefix match search for variable length character strings), is described, referencing FIG. 1A. This so-called longest prefix match search is a search for the longest character string that prefix-matches the search character string from among the set of character strings to be searched. This kind of longest prefix match search is used for example in the search for a routing target address in a router or for a dictionary look-up in an electronic dictionary.

The example shown in FIG. 1A shows the character strings “BEAB”, “BAB”, “ABEAB”, “AB”, and “A” stored as the character strings to be searched (stored patterns) 10. The character strings to be searched could be routing targets for routing target searches or dictionary head words for dictionary lookup.

When these character strings to be searched 10 are searched using the search character string 40a “ABEABC”, the character strings to be searched that prefix-match search character string 40a are “A”, “AB”, and “ABEAB”. Because the longest character string to be searched among these three is “ABEAB”, “ABEAB” is the search result character string 50a for the longest prefix match search.

When these character strings to be searched 10 are searched using the search character string 40b “ABE”, the character strings to be searched that prefix-match are “A” and “AB”. Because the longest character string to be searched among these two is “AB”, “AB” is the search result character string 50b. Also, although the search character string 40b “ABE” prefix-matches the character string “ABEAB” included in the character strings to be searched 10, the longest prefix match search of this application, as was noted above, is a search that searches the set of character strings to be searched for the longest character string that prefix-matches the search character string, and because the character string “ABEAB” does not prefix match the search character string 40b “ABE”, it cannot be obtained as a search result character string.

Also, when the character strings to be searched 10 is searched for the search character string 40c “AB”, the character strings to be searched that prefix-match are the same “A” and “AB” as above. Because the longest character string to be searched among these two is “AB”, the same “AB” as above becomes the search result character string 50b.

Among the longest prefix match searches for a variable length character string noted above, there is a method that divides the variable length character string into a front section with a certain length as a prefix and the remaining part as a suffix, and searches using the prefix as an index, and, after reducing the number of candidates, collates them with the suffix.

Among these kinds of methods, a variable length character string search apparatus and search method have been proposed (Patent Document 1) that seek to increase search efficiency even if the lengths of duplicate parts in the stored patterns that are subject to searches are variable, by making prefixes with a plurality of lengths to be indexes, enabling an index with an appropriate length to be selected.

Also, in order to perform the search at high speed, a method using the data configuration called a Patricia tree is well known. A Patricia tree is one kind of a binary tree and a node of a Patricia tree is formed to include an index key, a test bit position for a search key, and right and left link pointers. Although search processing using a Patricia tree has the advantages of being able to perform a search by testing only the required bits and of only being necessary to perform an overall key comparison one time, there are the disadvantages of an increase in storage capacity caused by the inevitable two links from each node, the added complexity of the decision processing because of the existence of back links, the delay in the search processing by returning by a back link in order to compare with an index key for the first time, and the difficulty of data maintenance such as adding and deleting a node.

Whereat, this applicant proposed (Patent Document 2 and Patent Document 3) a bit string search apparatus and search method preparing a data configuration called a coupled-node tree in order to resolve the disadvantages of the Patricia tree, reduce the amount of memory needed, speed up the search, and simplify data maintenance.

The coupled-node tree disclosed in Patent Document 2 and Patent Document 3 prepares branch nodes that have data for link targets and leaf nodes that have index keys that are search targets. And this tree configuration is configured from a root node and node pairs disposed in adjacent storage areas, consisting of a branch node and a leaf node, or two branch nodes, or two leaf nodes.

The branch node includes a discrimination bit position in the search key and information indicating a position of a primary node, which is one node of a node pair that is a link target, and the leaf node includes an index key that is a target bit string of a bit string search. The root node is a branch node unless there is only one node in the tree.

Although the discrimination bit position in the search key is the same as the inspection bit position of a Patricia tree from the point that the bit value at that position in the search key is being used, they differ in the point that the bit value at the inspection bit position of a Patricia tree is analyzed and used to obtain the link target whereas the bit value at the discrimination bit position of a coupled-node tree is used in a calculation to obtain the node that is the link target.

The execution of a search using a search key is performed, at each branch node including the root node, by successively linking to one of the nodes in the node pair that is the link target in accordance with the bit value in the search key at the discrimination bit position included in that branch node until a leaf node is reached.

When a leaf node is reached, the index key kept in the leaf node is extracted. The extracted index key can be compared with the search key and if they coincide the search can be taken to be a success, and if no index key that is an object of searches matches the search key, the search can be taken to be a failure. Or, the extracted index key can be simply taken to be the search result key.

Also, this applicant has proposed (Patent Document 4) that the leaf nodes in a coupled-node tree do not directly include the index keys that are the object of searches and instead include a reference pointer which is a pointer to an area holding the index keys.

To simplify notation hereinafter, in the description below the wording “leaf node including an index key” and “index key included in a leaf node” may at times be used even if the leaf node includes a reference pointer instead of an index key. Also, for a coupled-node tree, which has leaf nodes that include index keys, expressions such as “a coupled-node tree wherein index keys are stored” or “index keys stored in a coupled-node tree” may at times be used. Furthermore, expressions such as “index key related to the leaf node” or “leaf node related to the index key” may be used regardless of whether the leaf node includes an index key or a reference pointer to the index key.

FIG. 1B is a drawing that describes an exemplary configuration of a coupled node tree that is stored in an array, proposed in Patent Document 4. Although the data indicating the position of the link target, held by a branch node, can be made to be address information for a storage device, by using an array which consists of array elements whose size is the larger of the storage capacities for the areas required by a branch node or a leaf node, each node position can be expressed as an array element number and the size of the position information can be reduced.

Referring to FIG. 1B, a node 101 is located at the array element of the array 100 with the array element number 10. The node 101 is formed by a node type 102, a discrimination bit position 103, and a coupled node indicator 104. The value of the node type 102 is “0”, which indicates that the node 101 is a branch node. The value 1 is stored in the discrimination bit position 103 in this example. The coupled node indicator 104 has stored in it the array element number 20 of the primary node of the node pair of the link target. To simplify notation hereinafter, the array element number stored in a coupled node indicator is sometimes called the coupled node indicator. Also, the array element number stored in a coupled node indicator is sometimes expressed as the code appended to that node or the code attached to a node pair.

The array element with the array element number 20 has stored therein a node [0] 112, which is the primary node of the node pair 111. A node [1] 113 forming a pair with the primary node is stored into the next, adjacent, array element (array element number 20+1). Node [0] 112 is also a branch node like node 101. The value 0 is stored in the node type 114 of the node [0] 112, the value 3 is stored in the discrimination bit position 115, and the value 30 is stored in the coupled node indicator 116. Also, node [1] 113 is formed from a node type 117 and a reference pointer 118a. The value 1 is stored in the node type 117, indicating that node [1] 113 is a leaf node. In the reference pointer 118a is stored a pointer referencing a storage area for a code string that is the target of searches. To simplify notation hereinafter, the data stored in the reference pointer may also at times be called the reference pointer.

Primary nodes are indicated as the node [0], and nodes that are paired therewith are indicated as the node [1]. The node paired with a primary node may at times also be called a non-primary node. Also the node stored in an array element with some array element number is called the node of that array element number and the array element number stored in the array element of that node is also called the array element number of the node.

The contents of the node pair 121 formed by the node 122 and the node 123 that are stored in the array elements having array element numbers 30 and 31 are not shown.

The 0 or 1 that is appended to the node [0] 112, the node [1] 113, the node 122, and the node 123 indicates respectively to which node of the node pair linking is to be done when performing a search using a search key. The node in the position where a “0” is appended may at times be called the node on the [0] side and the node in the position where a “1” is appended may at times be called the node on the [1] side. Also the position in a node pair wherein a “0” is appended may at times be called the node [0] position and the position in a node pair wherein a “1” is appended may at times be called the node [1] position. In a search using a coupled node tree, linking is done to the node at the node [0] position or the node [1] position depending on the bit value of the search key at the discrimination bit position of the immediately previous branch node. Therefore, by adding the bit value of the discrimination bit position of the search key to the coupled node indicator of the immediately previous branch node, it is possible to determine the array element number of an array element storing a node at the link target.

Although in the above-noted example the smaller of the array element numbers at which the node pair is located is used as the coupled node indicator, it will be understood that it is also possible to use the larger of the array element numbers in the same manner.

Furthermore, these applicants have also proposed a bit search method using a coupled-node tree that includes index keys comprising bit strings that include a “don't care” bit (Patent Document 5).
Patent Document 1: JP 2005-165598 A
Patent Document 2: JP 2008-015872 A
Patent Document 3: JP 2008-112240 A
Patent Document 4: JP 2008-269503 A
Patent Document 5: JP 2009-015530 A

### SUMMARY OF THE INVENTION

Although bit string searches using a coupled-node tree have the special features of requiring less memory capacity for holding the tree, their search speed being very fast, and their maintenance being easy, still the technology for applying a coupled-node tree to a longest prefix match search for variable length character strings or variable length code strings currently does not exist.

Whereat, this invention has the objective of proposing a coupled-node tree that can be applied to longest prefix match searches for variable length code strings and realizing a longest prefix match search for variable length code strings that actualizes the special characteristics that are intrinsic to coupled-node trees.

In order to achieve the objective noted above, in accordance with this invention, a search is performed on a coupled-node tree with a configuration prescribed by the bit values of index keys whose bit strings are encodings of the search target code strings, by means of an encoded search key which is a bit string that encodes a search key consisting of a code string.

The coupled-node tree, as noted above, has a configuration prescribed by the bit values of index keys whose bit strings are encodings of the search target code strings, and it has a root node and node pairs, which are compositional elements of a tree, and which are two nodes, a primary node and a non-primary node, disposed in adjacent storage areas. The nodes have an area for storing a node type that indicates whether that node is a branch node or a leaf node. The branch node has, in addition to the node type, an area for storing a discrimination bit position in the encoded search key and an area for storing information indicating the position of the primary node of a node pair that is the link target. The leaf node has, in addition to the node type, an area for storing the search target code string or a reference pointer pointing to a storage area for the search target code string. Also, regardless whether the leaf node includes the search target code string or includes a reference pointer to the search target code string the wording “the search target code string related to the leaf node” or “the leaf node related to the search target code string” may at times be used.

The encoded search key is a bit string with differentiating bits appended at the head position for the bit strings for each code included in the code string that is the above noted search key, which indicate that there are following codes (hereinbelow this may be called continue bits) and with a differentiating bit appended at the tail end of the code string, which indicates that there are no more following codes (hereinbelow this may be called an end bit). Also, the index keys are bits strings wherein a continue bit is appended at the head of the bit string for each code included in the search target code string and an end bit is connected to the tail end of the code string.

Thus, when considering that a non-significant code with length 0 can exist both in the code string that is the search key and at the tail end of the search target code strings, the differentiating bit differentiates whether the codes following the differentiating bit are significant codes or non-significant codes. The differentiating bit can also indicate whether or not there are any following codes.

In accordance with this invention, first, an initial search is executed that searches a coupled-node tree by means of an encoded search key and obtains a search target code string as the search result code string and then stores in the stack information indicating the position of a branch node of the branch nodes traversed during the search, for which the value of the discrimination bit position of the branch node matches the position wherein one of the differentiating bits in the bit string configuring the encoded search key exists (hereinafter the branch node may be called the code string delimiter branch node) and information for accessing the search target code string that is related to the code string terminus node, which is the node of the node pair that is the link target of code string delimiter branch node, whose node position is computed, when the value at the discrimination bit position has the value of the end bit. If the nodes configuring the node pair that is the link target of the code string delimiter branch node are defined as child nodes of the branch node and the branch node that is the link source is defined as the parent node, the information indicating the position of the code string delimiter branch node is stored in the stack as information indicating the position of the parent node. Also, for example, if information indicating the position of the node that is one of the child nodes of the code string delimiter branch node is made to be information for accessing the search target code string related to the code string terminus node, that information is stored as information indicating the position of that child node. By the definition of a code string delimiter branch node, of the child nodes, either the node on the [0] side or the node on the [1] side is a leaf node.

Next, a longest prefix match search is executed by encoding the search result code string as an index key and comparing it with the encoded search key, and a determination is made whether the search result code string is the longest prefix matching code string (hereinbelow this may be called the longest prefix matching key) and if the search result code string is not the longest prefix matching key, the information for accessing a search target code string related to a code string terminus node is read out from the stack and a search target code string is searched for, and a longest prefix matching key is obtained from the search target code strings.

In accordance with this invention, the configuration of a coupled-node tree is made to be that which is prescribed by the index keys, encoded by combining the bit strings corresponding to the codes with differentiating bits that indicate whether or not following codes exists in the search target code strings. An initial search is done using an encoded search key that encodes the search key in the same way as the search target code strings, and the path traversed during the search is memorized. Then, a longest prefix match search using a search key consisting of a code string can be realized by searching the search result code string by the initial search and search target code strings accessed by means of the information about the search path that is memorized.

### BRIEF DESCRIPTION OF THE DRAWINGS

FIG. 1A is a drawing describing an example of a longest prefix match search for a variable length character string.

FIG. 1B is a drawing describing an exemplary configuration of a coupled node tree stored in an array.

FIG. 2 is a drawing describing one example of an encoding method for code strings in one embodiment of the present invention.

FIG. 3 is a drawing conceptually describing a tree structure of a coupled node tree in an embodiment of the present invention.

FIG. 4 is a drawing describing an exemplary hardware configuration for embodying the present invention.

FIG. 5 is a drawing describing an example of the processing flow for basic search processing in one embodiment of the present invention.

FIG. 6 is a drawing describing an example of the processing flow for code string searches in one embodiment of the present invention.

FIG. 7 is a drawing describing an example of the processing flow for the encoding process in one embodiment of the present invention.

FIG. 8A is a drawing showing conceptually the flow for the initial search using an encoded search key.

FIG. 8B is a drawing describing an example of the processing flow for an initial search.

FIG. 9A is a drawing showing conceptually the processing flow for a longest prefix match search.

FIG. 9B is a drawing describing an example of the processing flow for the first stage of a longest prefix match search.

FIG. 9C is a drawing describing an example of the processing flow for the middle stage of a longest prefix match search.

FIG. 9D is a drawing describing an example of the processing flow for the last stage of a longest prefix match search.

FIG. 10 is a drawing describing an example of the contents of the search path stack and its relation to index keys.

FIG. 11A is a drawing describing conceptually an example of a longest prefix match search when the index key obtained at the initial search prefix-matches the encoded search key.

FIG. 11B is a drawing describing conceptually an example of a longest prefix match search when the encoded bit length of the index key obtained at the initial search is shorter than the encoded bit length of the encoded search key.

FIG. 11C is a drawing describing conceptually an example of a longest prefix match search when the encoded bit length of the index key obtained at the initial search is longer than the encoded bit length of the encoded search key.

FIG. 12 is a drawing describing an example of the processing flow for generating a coupled-node tree in one embodiment of the present invention.

FIG. 13A is a drawing describing an example of the processing flow for the first stage of insertion processing in one embodiment of the present invention.

FIG. 13B is a drawing describing an example of the processing flow for the middle stage of insertion processing in one embodiment of the present invention.

FIG. 13C is a drawing describing an example of the processing flow for the last stage of insertion processing in one embodiment of the present invention.

FIG. 14A is a drawing describing an example of the processing flow for the prior stage of deletion processing in one embodiment of the present invention.

FIG. 14B is a drawing describing an example of the processing flow for the latter stage of deletion processing in one embodiment of the present invention.

FIG. 15 is a drawing showing an example of a function block configuration for a code string search apparatus in one embodiment of the present invention.

### DETAILED DESCRIPTION OF THE INVENTION

Next details about a preferred embodiment of this invention is described. Hereinbelow, after describing an example of an encoding method for the code string and an example of a coupled-node tree, the search processing, insertion processing, and deletion processing are each described. Also, although the description below assumes that the leaf nodes include a reference pointer pointing the storage area holding the search target code string, it is clear to one skilled in the art that the same description applies even if the leaf nodes include the search target code strings directly.

This invention takes as its object code strings consisting of codes used to distinguish not only letters but also any symbol or any item. And this invention does not handle directly the code strings just as they are but rather handles strings of encoded codes that encode each code included in the code string. As was noted above, each code is encoded as a combination of a differentiating bit indicating whether or not a following code exists or not and a plurality of bits expressing in bits each code. This invention performs searches and so forth by means of encoded code strings that are a string of encoded codes encoding each code in the code string.

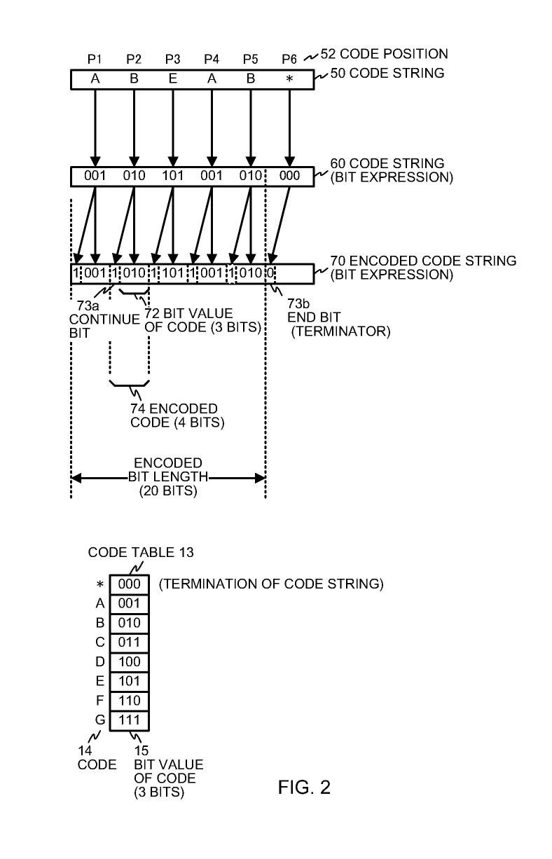

One example of an encoding method for code strings for the code string search apparatus, search method, and program of this invention is described referencing FIG. 2.

The example shown in FIG. 2 shows 8 types of codes including each of the codes for “A”, “B”, “C”, “D”, “E”, “F”, and “G”, as well as the code “*” indicating the end of the code string. Each code is, respectively, expressed in a bit string consisting of a plurality of bits, and these strings are expressed, respectively, by the 3-bit values shown in code table 13.

Also, the code “*” is one equivalent to the non-significant code with a length of zero noted above, as will be understood by the description hereinbelow.

Here, a case is described wherein the code string 50, which is a concatenation of the codes “A”, “B”, “E”, “A”, and “B”, is encoded. The label 52 in the drawing indicates the code positions (in this example, P1 to P6). As shown in the drawing, the code string 50 consists of six codes with the code “A” at code position P1, the code “B” at code position P2, the code “E” at code position P3, the code “A” at code position P4, the code “B” at code position P5, and the terminal code “*”, which indicates the end of the code string, at code position P6.

The above noted code string 50 “ABEAB*” becomes the code string expressed in bits shown by the label 60 in the drawing, by using the bit values of the codes described in the above noted code table 13. In this example, the code string expressed in bits 60 is “001 010 101 001 010 000”.

As is noted above, each code in the code string is encoded by combining a differentiating bit, which shows whether or not there is a following code, with the plurality of bits that are the bit-expression for each code. As shown in FIG. 2, each code included in code string 50, with exception of the code showing the string end, is encoded into the 4-bit encoded codes 74 consisting of the 1-bit continue bit 73a and the bit value for each code 72 (3 bits). In the example in FIG. 2, the bit value for the continue bit 73a is a “1”. Also the terminal code “*” that indicates the end of the code string is encoded with the end bit 73b (bit value “0”) that shows the string end. By so doing, the above noted code string 50 is encoded into the encoded code string 70 configured from the 4-bit encoded codes 74, consisting of the 1-bit continue bit 73a and the bit value for each significant code 72 (3 bits), and from the end bit 73b that shows the string end. In the description hereinbelow, an encoded code string expressed in bits may at times be called an encoded bit string.

Also it is assumed that the end bit 73b, showing the string end, is not included in the “encoded bit length” that shows the length of the encoded code string. Thus, as shown in FIG. 2, the encoded bit length of encoded code string 70, which is the encoding of code string 50, is 20 bits.

In accordance with this encoding method, it is easy to determine from the bit expression of the encoded code string whether or not there is a following significant code in the code string before encoding. In other words, the (number of bits accommodating a code [in this example, 3]+1) n-th bit in the encoded code string (n being an integer with a value of 0 or greater) is the position of a differentiating bit and depending on whether the bit value at this position is a “0” or a “1”, a determination can be made whether or not there is a following significant code.

Also, in the above the value of the continue bit is taken to be a “1”, and value of the end bit is taken to be a “0”, but the reverse is also possible. Also, a differentiating bit consisting of a plurality of bits may also be used.

This invention configures a coupled-node tree by means of a set of index keys that are encoded bit strings that encode, with the above noted encoding method, search target code strings and this invention performs searches and so forth using an encoded search key that is an encoded bit string that encodes, with the above noted encoding method, a search key consisting of a code string.

Next an example of a coupled-node tree in one embodiment of the present invention is described.

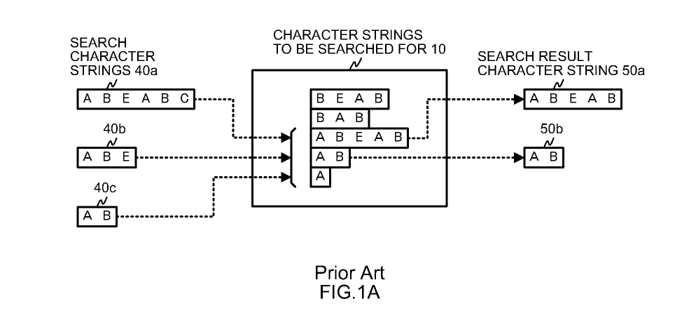

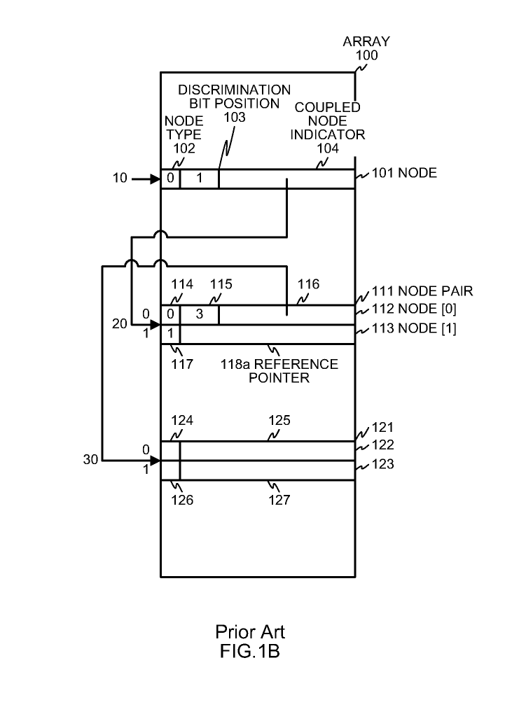

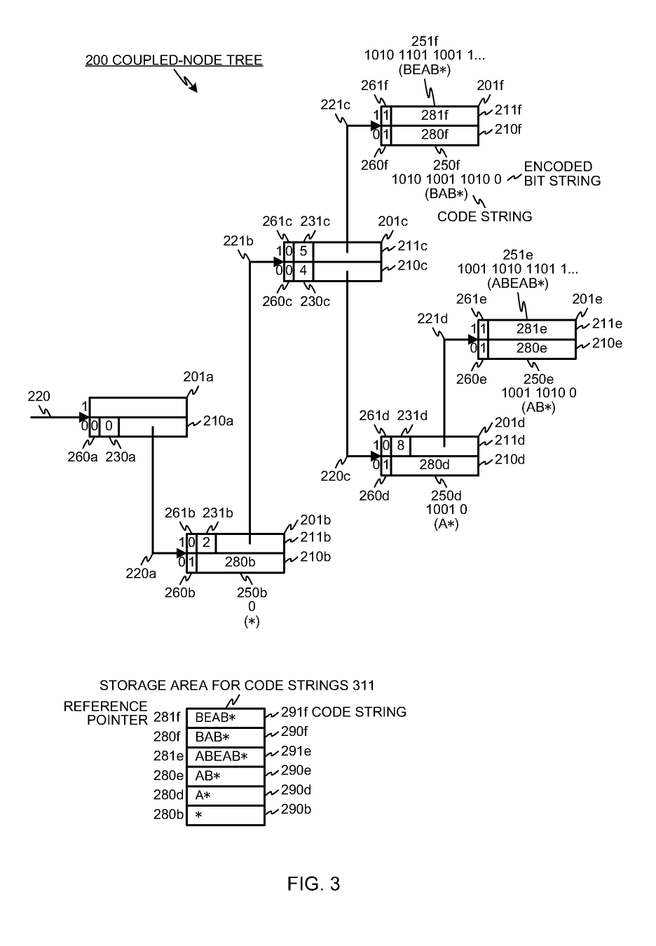

FIG. 3 is a drawing conceptually describing a tree structure of a coupled node tree in an embodiment of the present invention. Here, an example of the coupled-node tree 200, which contains the search target code strings “BEAB*”, “BAB*”, “ABEAB*”, “AB*”, “A*” and “*” as encoded index keys, is described. These code strings are the code strings in the example showing in the above noted FIG. 1A, with the terminal code “*” showing the end of the code string appended to each, and furthermore a code string consisting of only the terminal code “*” is added as a code string.

Here, the reason why the coupled-node tree 200 is made to include also a code string consisting of only the terminal code “*” is to prevent a case wherein, in a longest prefix match search, details of which are described hereinbelow, not even 1 of the search target code strings prefix-matches the search key.

Of course, not even 1 of the search target code strings prefix-matching the search key can be allowed and the coupled-node tree 200 can also be made so that it does not include a code string consisting of only the terminal code “*”.

Details of how a search result key can always be obtained for any search with any kind of search key by making the coupled-node tree 200 to include also a code string consisting of only the terminal code “*” are explained hereinbelow in the description of a longest prefix match search.

In the drawing the reference numeral 210a shows the root node. In the example shown, the root node 210a is the primary node of the node pair 201a located at the array element number 220.

In this tree structure, a node pair 201b is located below the root node 210a, and below that is located the node pair 201c. Below the node pair 201c are located the node pair 201f and the node pair 201d. Below the node pair 201d is located the node pair 201e. The 0 or 1 code that is appended before each node is the same as the labels that are appended before the array element numbers described in FIG. 1B.

In the example shown, the node type 260a of the root node 210a is “0”, thereby indicating that this is a branch node, and the discrimination bit position 230a indicates “0”. The coupled node indicator is 220a, which is the array element number of the array element in which the primary node 210b of the node pair 201b is stored.

The node pair 201b consists of node 210b and node 211b. Because a “1” is stored in the node type 260b of node 210b, this node is a leaf node and it includes the reference pointer 250b. The pointer that is stored in the reference pointer 250b references an area in the code string storage area 311 wherein is stored the code string 290b consisting of only the terminal code “*”. As was noted hereinabove, the pointer stored in reference pointer 250b may also be called the reference pointer and is expressed with the label 280b. The same applies to the other leaf nodes: the pointer stored in the reference pointer may at times be called a reference pointer. Also the “0” depicted immediately below the reference pointer 250b is the bit expression for the encoded code string that encodes the code string referenced by reference pointer 280b, and the (*) shows that that bit expression is the bit expression for the code string “*”. The same applies to the other leaf nodes. In the description hereinbelow, the bit expression for any arbitrary code string “ABC” may at times be notated as (ABC).

Also the node type 261b of node 211b is a “0”, indicating that the node is a branch node. A “2” is stored in the discrimination bit position 231b in node 211b, and the array element number of the array element 221b wherein is stored the primary node 210c of the node pair 201c is stored in the coupled node indicator for the link target.

The node pair 201c is configured by node 210c and node 211c. Both of their nodes types 260c and 216c are “0”, indicating that they are branch nodes. The discrimination bit position 230c in node 210c is a “4”, and the array element number of the array element 220c wherein is stored the primary node 210d of the node pair 201d is stored in the coupled node indicator.

Because a “1” is stored in the node type 260d for node 210d, this node is a leaf node, and the reference pointer 280d, which points to the area wherein is stored the code string “A*” shown with the label 290d, is stored in reference pointer 250d.

The node type 261d for node 211d that is a pair to node 210d is a “0”, and an “8” is stored in the discrimination bit position 231d. And the array element number of the array element 221d wherein is stored the primary node 210e of the node pair 201e is stored in the coupled node indicator.

The node pair 201e is configured by node 210e and node 211e, and their nodes types 260e and 261e are both “1”, indicating that both are leaf nodes. The reference pointer 280e, which points to the area wherein is stored the code string “AB*” shown with the label 290e, is stored in reference pointer 250e for node 210e, and the reference pointer 281e, which points to the area wherein is stored the code string “ABEAB*” shown with the label 291e, is stored in reference pointer 251e for node 211e.

The discrimination bit position 231c in node 211c, which is the other node of the above noted node pair 201c, is a “5”, and the array element number of the array element 221c wherein is stored the primary node 210f of the node pair 201f is stored in the coupled node indicator.

The node pair 201f is configured by node 210f and node 211f, and their nodes types 260f and 261f are both “1”, indicating that both are leaf nodes. The reference pointer 280f, which points to the area wherein is stored the code string “BAB*” shown with the label 290f, is stored in reference pointer 250f for node 210f, and the reference pointer 281f, which points to the area wherein is stored the code string “BEAB*” shown with the label 291f, is stored in reference pointer 251f for node 211f.

Next, the meaning of the coupled-node tree configuration is described.

The search target code strings in the coupled-node tree 200 shown in FIG. 3 and the encoded bit strings (index keys) that are the search target code strings encoded by the encoding method described referencing the above noted FIG. 2 are related as shown by Table 1 below.

TABLE 1

| code string to be | encoded bit string (index key) |
|---|---|
| searched for | 012345678901234567890 |
| BEAB* | 10101101100110100 |
| BAB* | 1010100110100 |
| ABEAB* | 100110101101100110100 |
| AB* | 100110100 |
| A* | 10010 |
| * | 0 |

In the above noted Table 1, significant code strings, those other than the code string “*”, have a “1” in the 0-th bit of their encoded bit string, and the encoded bit string for the code string “*” has a “0” for the value of the 0-th bit. Thus the code string “*” can be differentiated from the other code strings by a determination of the value at 0-th bit in the encoded bit string. In FIG. 3, the fact that the discrimination bit position 230a for root node 210a is a “0” derives from the fact that a code string “*” is included in the coupled-node tree. Node 210b, which is the link target when the value of 0-th bit in the encoded bit string is a “0”, contains the reference pointer 280b, which points to the area wherein is stored the code string “*”.

Next, if we look at the significant code strings in the encoded bit strings, we can see that the bits at bit 1 are alike in all being “0” while the bit at bit 2 is a “1” for the code strings “BEAB*” and “BAB*” and a “0” for the code strings “ABEAB*”, “AB*”, and “A*”.

Because there exist encoded bit strings whose bit values at bit 2 mutually differ, the discrimination bit position 231b for branch node 211b, which is the link target when the value at bit 0 in the encoded bit string is a “1”, has the value “2”, and when the value at bit 2 in the encoded bit string is a “0” a link is made to primary node 210c of the node pair 201c and when the value is “1” a link is made to node 211c.

When the branching at the above noted branch node 211b is seen from the point of view of the code string, that branching reflects the fact that the code positioned in the first code position in the code strings in the search target code strings is either an “A” or a “B”. In the description hereinbelow, branch nodes, like branch node 211b, wherein the value in the discrimination bit position does not coincide with the position of a differentiating bit, may be called a code distinguishing branch node. In the above noted example, although the first code is completely divided into whether the first code in the code string is an “A” or a “B” at code distinguishing branch node 211b by performing bifurcation, in general a code at any position in the code string is not completely divided at a code distinguishing branch node.

The discrimination bit position 230c in node 210c, which is the link target when the value at bit 2 in the encoded bit string is a “0”, has a “4”. This number is based on the fact that when we look at the bit values at bit 3 and thereafter in the encoded bit strings for the code strings “ABEAB*”, “AB*” and “A*”, for which the value at bit 2 in the above noted Table 1 is a “0”, we find that the value at bit 3 is a “1” in each of them and the value at bit 4 is a “1” for the code strings “ABEAB*” and “AB*” and a “0” for code string “A*. In other words, this branching is based on separating code strings wherein the number of significant codes is “1” from code strings wherein the number of significant codes is 2 or more. And the reference pointer 280d, which points to the area wherein is stored the code string “A*”, is stored in the primary node 210d of node pair 201d, which is the link target when the value at bit 4 in the encoded bit string is a “0”.

Also, an “8” is stored in the discrimination bit position 231d of node 211d, which is the link target when the value at bit 4 in the encoded bit string is a “1”. This number is based on the fact that when we look at the bit values at bit 5 and thereafter in the encoded bit strings for the code strings “ABEAB*” and “AB*”, for which the value at bit 2 is a “0” and the value at bit 4 is a “1”, we find that the values at bit 5 through bit 7 are the same, but the value at bit 8 is different. In other words, this branching distinguishes code strings wherein the number of significant codes is two from code strings wherein the number of significant codes is three or more.

And the reference pointer 280e, which points to the area wherein is stored the code string “AB*”, is stored in the primary node 210e (the link target when bit 8 in the encoded bit string is a “0”) of node pair 201e, which is the link target from node 211d, and the reference pointer 281e, which points to the area wherein is stored the code string “ABEAB*”, is stored in node 211e, which is the link target when bit 8 in the encoded bit string is a “1”.

The value “5” is stored as the discrimination bit position 231c in node 211c, which is the link target when bit 2 in the encoded bit string is a “1”. This number is based on the fact that when we look at the bit values at bit 3 and thereafter in the encoded bit strings for the code strings “BEAB*” and “BAB*”, for which the value at bit 2 is a “1”, we find that the values at bit 3 and bit 4 are the same, but the value at bit 5 is different. And the reference pointer 280f, which points to the area wherein is stored the code string “BAB*”, is stored in node 210f, which is the link target when the value at bit 5 in the encoded bit string is a “0”, and the reference pointer 281f, which points to the area wherein is stored the code string “BEAB*”, is stored in node 211f, which is the link target when the value at bit 5 in the encoded bit string is a “1”. The branching at node 211c, which is a code distinguishing branch node, reflects the fact, among the code strings in the search target code strings at that point, the code positioned in the second code position is either that for an “E” or that for an “A”.

In this way, the configuration of a coupled-node tree is prescribed by the bit values at each bit position in each key included in the set of index keys (encoded bit strings that encode the search target code strings).

In other words, delta information about the index keys can be said to be stored in the coupled-node tree.

And a branch is taken at each bit position with a mutually differing bit value, in the sequence from the bit position closest to the beginning of an index key, to the node for which the bit value is a “1” or to the node for which the bit value is a “0”. Also, the magnitude relation among the code strings is not changed by the encoding. From this fact, when we traverse the tree to leaf nodes giving priority to the node [1] side and to the depth direction in the tree and when we look at the search target code strings stored in those leaf nodes, or referenced by means of the reference pointer stored in those leaf nodes, we can be see that the search target code strings are sorted in descending order.

Also, because the coupled-node tree of this invention is one wherein is stored encoded bit strings that encode the search target code strings, it has the special characteristic that the node [0] that is the link target of a code string delimiter branch node is a leaf node. In the example of the coupled-node tree 200 shown in FIG. 3, the code string delimiter branch nodes are the root node 210a, node 210c, and node 211d. The nodes [0] that are, respectively, the link targets of those nodes are node 210b, node 210d, and node 210e, and all of these are leaf nodes. The reason for this is that the bit value is a “0” at the discrimination bit position in a code string delimiter branch node in encoded bit strings related to leaf nodes disposed below the node [0] that is the link target of the code string delimiter branch node, in other words, the value of the differentiating bit in the encoded bit strings is a “0”. Thus, there can be only one encoded bit string related to a leaf node disposed below a node [0], and thus there cannot be a further branching from the node [0]. Furthermore, the code string related to the above noted node [0] prefix-matches the code strings related to the leaf nodes disposed below the child node on the [1] side that is a pair with that node [0].

Also, of the child nodes for the above noted code string delimiter branch node, the fact that the node [0] is a leaf node corresponds to the fact that the code “*” is encoded as a “0”. It is clear that if the code “*” is encoded as a “1”, of the child nodes for the code string delimiter branch node, the node [1] becomes the leaf node. Here, of the child nodes for the code string delimiter branch node, the leaf node that branches by means of the bit value that shows that a following code does not exist is called a code string terminus node or a code string terminus child node, and the node that is a pair of that node is called a code string linked node or a code string linked child node. And thus the code string terminus node is a leaf node. Also, the code string related to the code string terminus node prefix-matches the code strings related to the leaf nodes disposed below the code string linked node that is a pair to that code string terminus node. Furthermore, it is clear that the length of the code string related to the code string terminus node is shorter than the lengths of the code strings related to the leaf nodes disposed below the code string linked node that is a pair to the code string terminus node.

Also because a coupled-node tree can be identified by the array element number of the root node, the coupled-node tree can be managed using the array element number of the root node. Thus the array element number of the root node for the coupled-node tree is taken to be registered in the coupled-node tree management means.

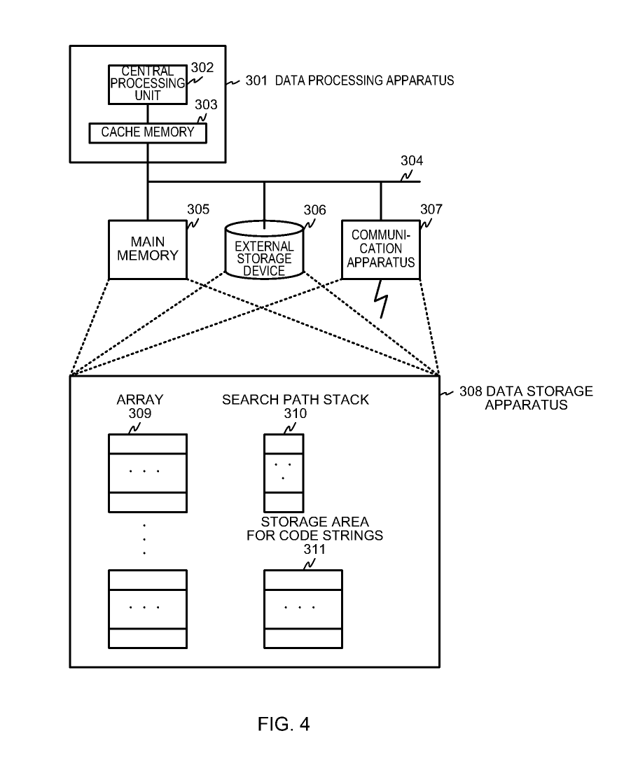

FIG. 4 is a drawing describing an exemplary hardware configuration for embodying the present invention.

Search processing and data maintenance are implemented with the search apparatus of the present invention by a data processing apparatus 301 having at least a central processing unit 302 and a cache memory 303, and a data storage apparatus 308. The data storage apparatus 308, which has an array 309 into which is disposed a coupled node tree, and a search path stack 310, into which are stored array element numbers of nodes which are traversed during the search, and code string storage area 311, can be implemented by a main memory 305 or a storage device 306, or alternatively, by using a remotely disposed apparatus connected via a communication apparatus 307. The array 100 in FIG. 1B is one embodiment of the array 309.

In the example shown in FIG. 4, although the main memory 305, the storage device 306, and the communication apparatus 307 are connected to the data processing apparatus 301 by a single bus 304, there is no restriction to this connection method. The main memory 305 can be disposed within the data processing apparatus 301, and can be implemented as hardware within the central processing unit 302. It will be understood that it is alternatively possible to select appropriate hardware elements in accordance with the usable hardware environment and the size of the index key set, for example, having the array 309 held in the storage device 306 and having the search path stack 310 held in the main memory 305.

Also, although it is not particularly illustrated, a temporary memory area can of course be used to enable various values obtained during processing to be used in subsequent processing.

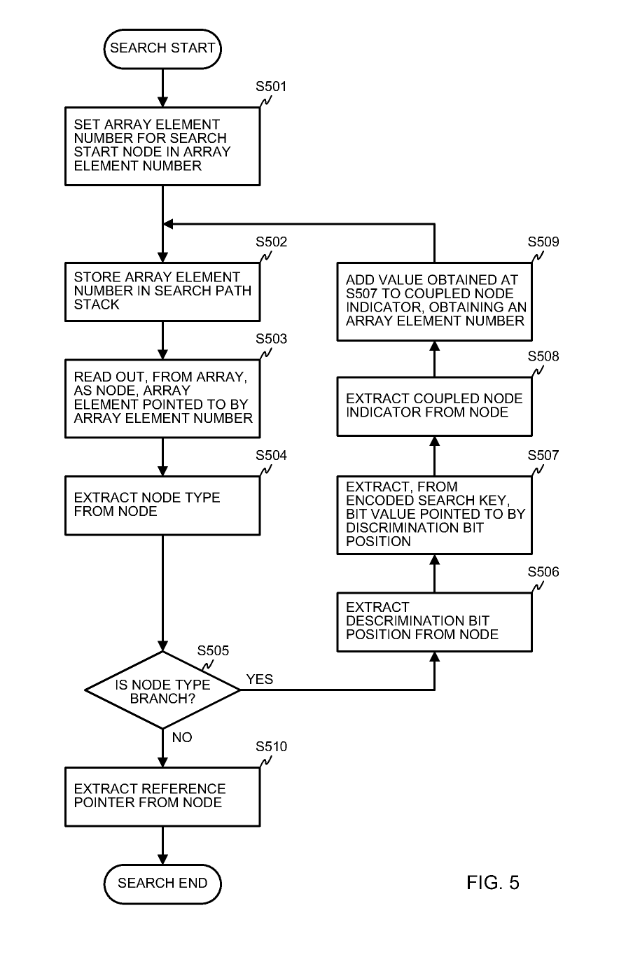

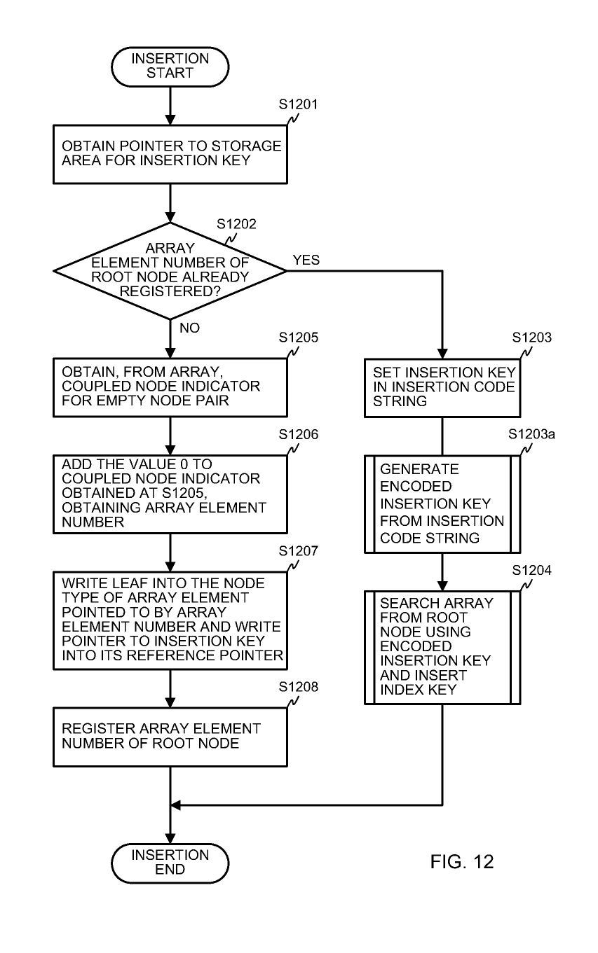

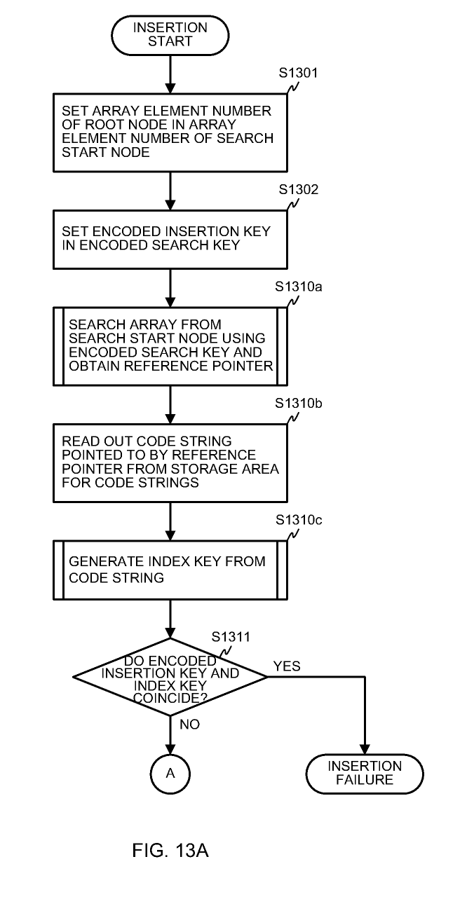

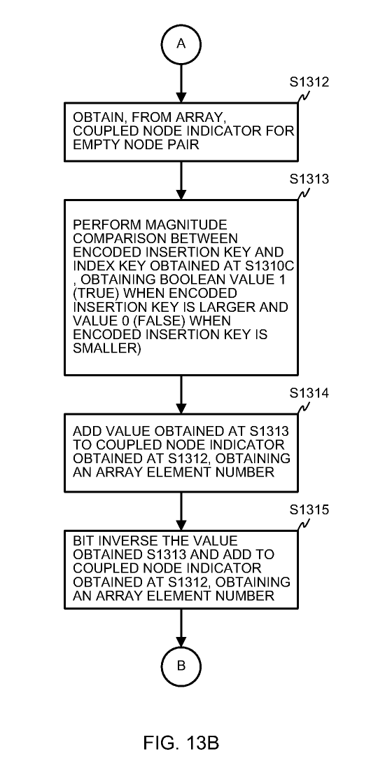

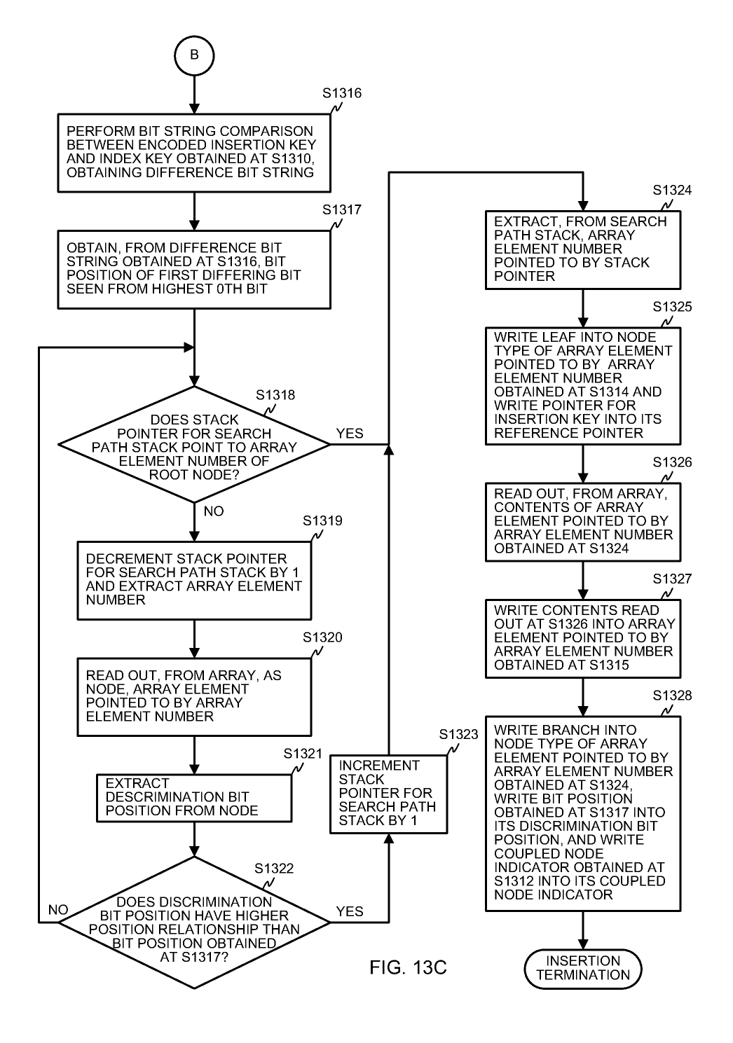

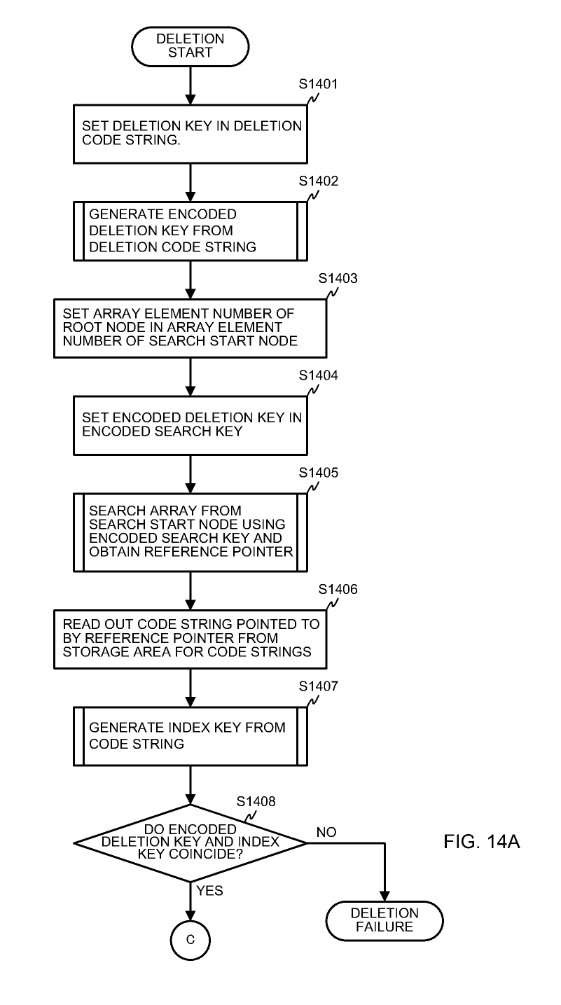

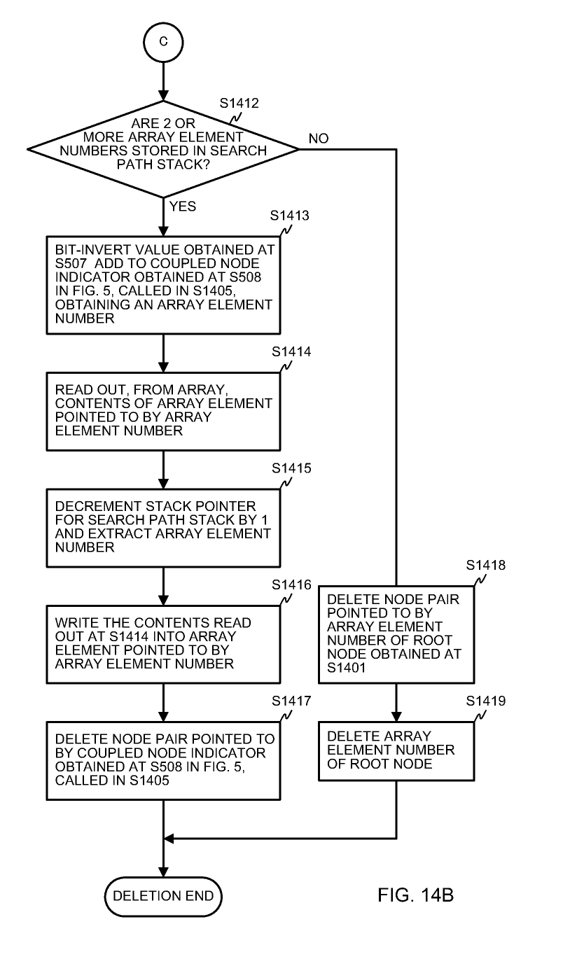

Basic search processing using this kind of a coupled-node tree is described referencing FIG. 5. The basic search processing exemplified in FIG. 5 is executed in the insertion processing described hereinbelow referencing FIG. 12 and FIG. 13A to FIG. 13C and the deletion processing described hereinbelow referencing FIG. 14A to FIG. 14B. And the processing flow exemplified in FIG. 5 is a variation on the processing flow for search processing exemplified in the above noted Patent Document 4. Also, although various variables such as an array element number are set temporarily in a storage area and used during execution, the areas wherein those variables are stored may at times be called by the name of those variables. For example, when “set the array element number of the search start node in the array element number” is said, it means set the array element number of the search start node in the area wherein is stored the array element number or set the array element number of the search start node in the variable called the array element number.

In a preferred embodiment of this invention, a search path stack is prepared for holding the array element numbers of the array elements wherein are stored nodes passed during a search as a means for remembering the path traversed in a search of a coupled-node tree. As shown in FIG. 5, at the beginning of search processing, at step S501, the array element number of the search start node is set in the array element number. The array element corresponding to the array element number set therein is that which holds any arbitrary node configuring the coupled-node tree. The search start node is set in accordance with the various processing that uses the basic search processing shown in the example in FIG. 5.

Next, at step S502, the array element number set at step S501 or obtained at step S509 noted below is stored in the search path stack, and at step S503, the array element corresponding to that array element number is read out as the node to be referenced. Then, at step S504, the node type is extracted from the read-out node, and at step S505, a determination is made whether the node type is that of a branch node.

If the determination at step S505 is that the read-out node is a branch node, processing proceeds to step S506, wherein information regarding the discrimination bit position is extracted from the node, and furthermore, at step S507, the bit value corresponding to the extracted discrimination bit position is extracted from the encoded search key. Then, at step S508, the coupled node indicator is extracted from the node, and at step S509, the bit value extracted from the encoded search key is added to the coupled node indicator and the result is made to be a new array element number and processing returns to step S502.

Thereinafter, the processing from step S502 to step S509 is repeated until the determination in step S505 is that of a leaf node and processing proceeds to step S510. At step S510, the reference pointer is extracted from the leaf node, and processing is terminated.

In this way, the search terminates when a leaf node is reached, and the array element numbers of the array elements holding the branch nodes traversed during the search up to the leaf node have been successively stored in the search path stack.

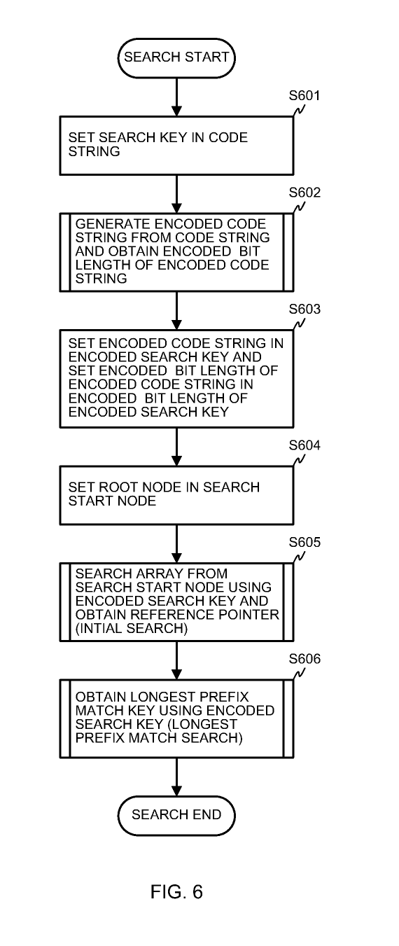

Next, code string search processing in one embodiment of the present invention is described referencing the flowchart in FIG. 6. In the search processing in FIG. 6, the desired code string is set as the search key and the coupled-node tree is searched using an encoded search key that encodes that search key.

The search processing in FIG. 6 is the processing to obtain a search result code string corresponding to the “longest prefix matching key,” provided that an index key that satisfies the condition described below for such a “longest prefix matching key” is stored in the coupled-node tree. Although if no index key satisfying the condition for such a “longest prefix matching key” is stored in the coupled-node tree, the search is taken to be failure and processing is terminated, because, as is described later, in one embodiment of this invention, the code “*” is included among the code strings to be searched for, even if, in reality, no index key satisfying the condition for such a “longest prefix matching key” is stored in the coupled-node tree, the index key corresponding to the code “*” is obtained as a “pro form a” longest prefix matching key.

In this preferred embodiment of the invention, the longest prefix matching key is the longest of the index keys that prefix-match the encoded search key, which is an encoding of the search key. An index key that prefix-matches the encoded search key coincides perfectly with the encoded search key throughout the length of that index key. Because an index key that is exactly the same as the encoded search key is the longest index key of all the index keys that prefix-match the encoded search key, it is the longest prefix matching key.

As shown in FIG. 6, first, at step S601, the desired code string is set in the code string as the search key.

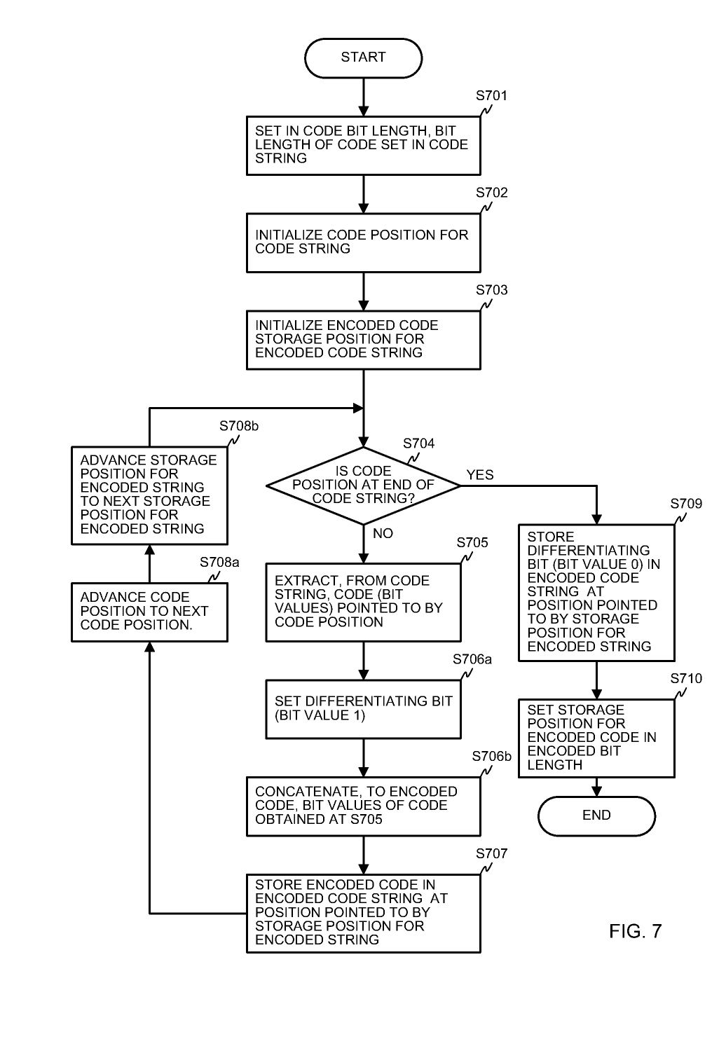

Next, proceeding to step S602, encode processing is done wherein the search key set in the code string is encoded using the encoding method described referencing FIG. 2, an encoded code string is generated, and information about the encoded bit length of the encoded code string is obtained. Details of the encode processing are described hereinafter referencing FIG. 7. Next, in step S603, the encoded code string generated at step S602 is set in the encoded search key, and the encoded bit length of the encoded code string obtained at step S602 is set in the encoded bit length of the encoded search key.

The processing of the above noted step S601 and step S603 applies to the search key the encode processing in step S602, which is the encode processing shown in FIG. 7 and common to various kinds of code strings. Instead of using the shared encode processing shown in FIG. 7, the processing shown in FIG. 7 can also be replaced by a special code string encoding for encoding search keys and that encoding can be performed. In the description of encode processing hereinbelow, even in the case that a special encoding is done, the notation may at times be that the encoding is implemented by the processing flow shown in FIG. 7.

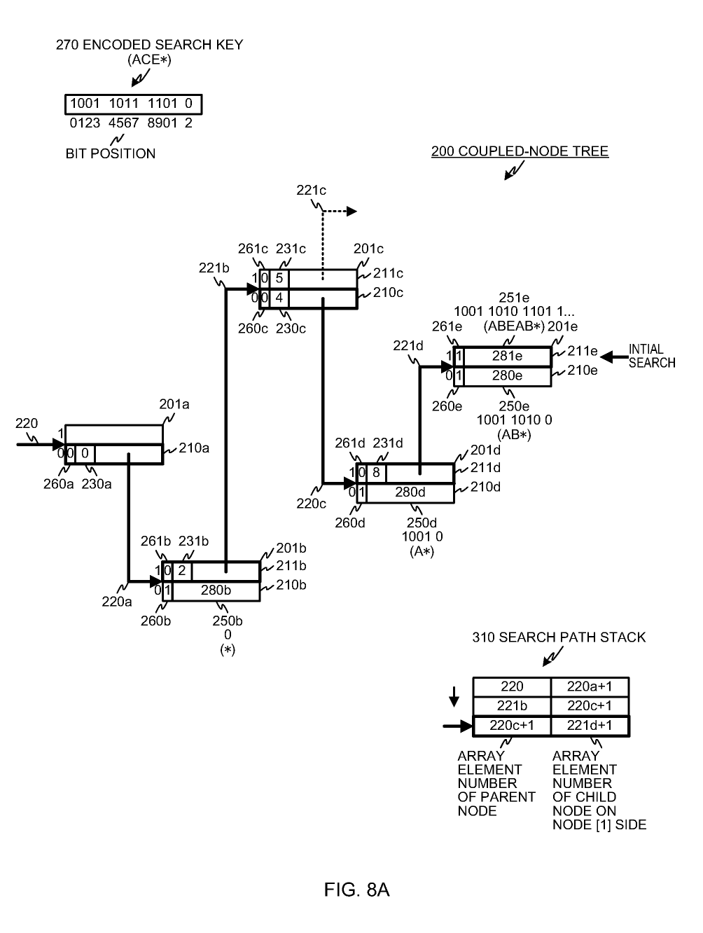

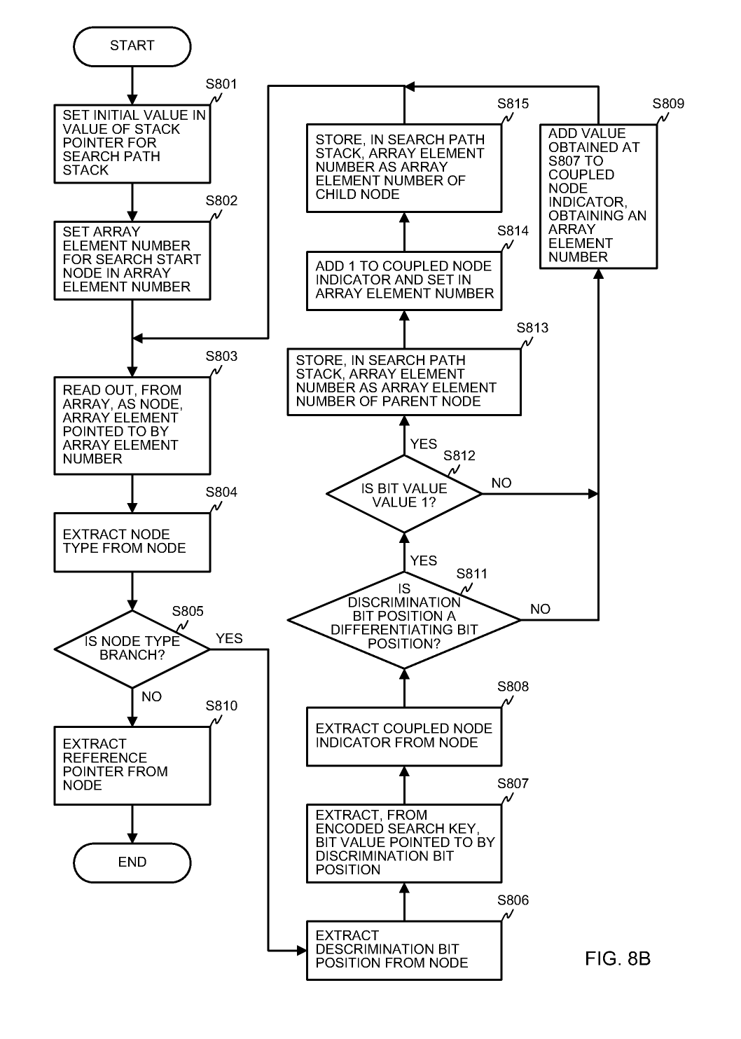

Continuing, at step S604, the root node of the coupled-node tree that is the object of searches is set in the search start node, and next, at step S605, initial search processing is executed. This processing is the processing to use the encoded search key and search, from the search start node, the array holding the nodes of the coupled-node tree, and to obtain a reference pointer as the search result while at the same time storing in the search path stack 310 the array element numbers of the code string delimiter branch nodes and code string linked nodes traversed up to the end of the search. Details of the processing in step S605 are described hereinafter referencing FIG. 8A and FIG. 8B.

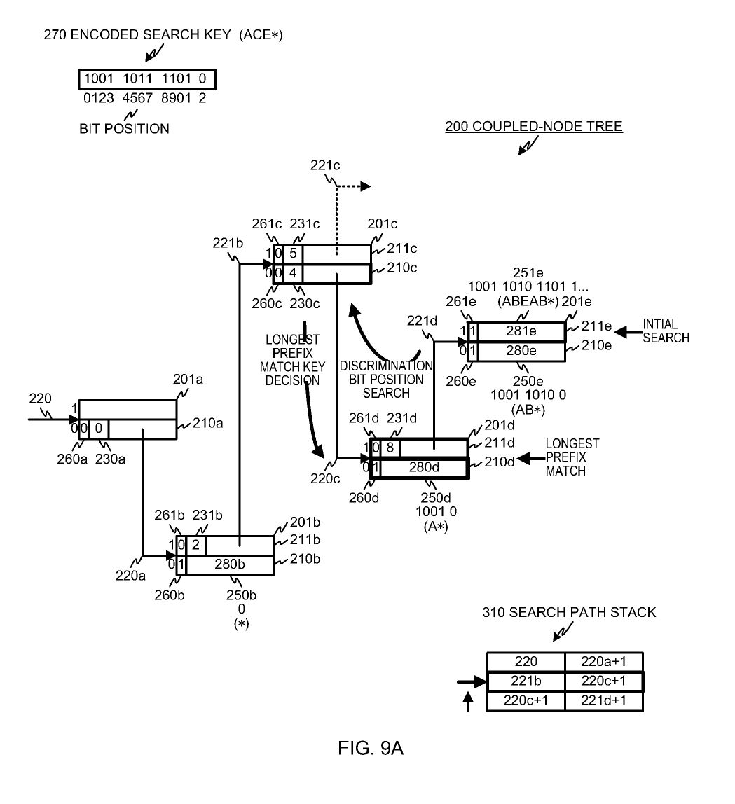

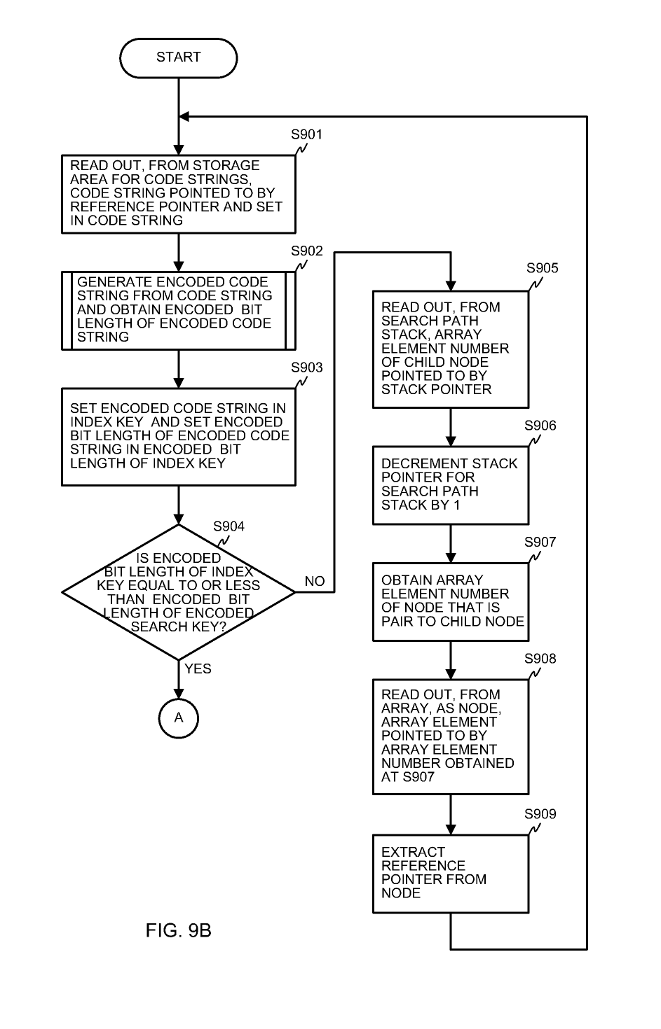

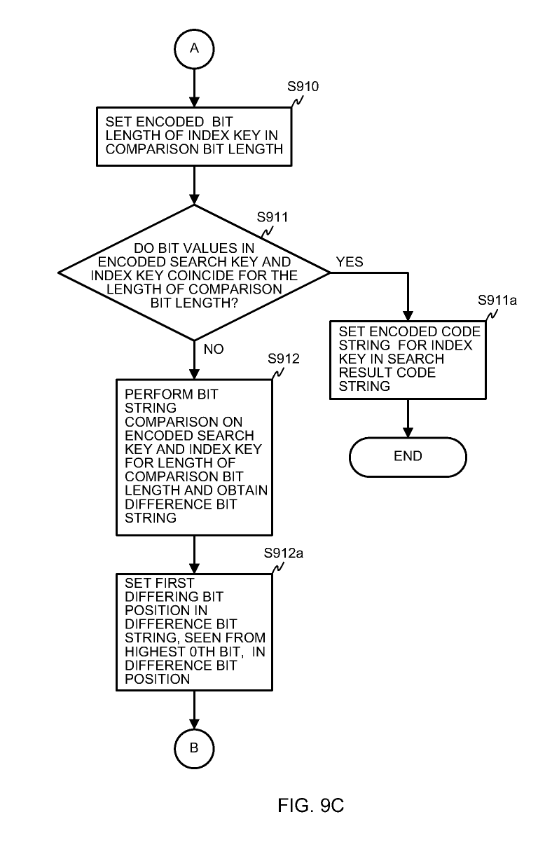

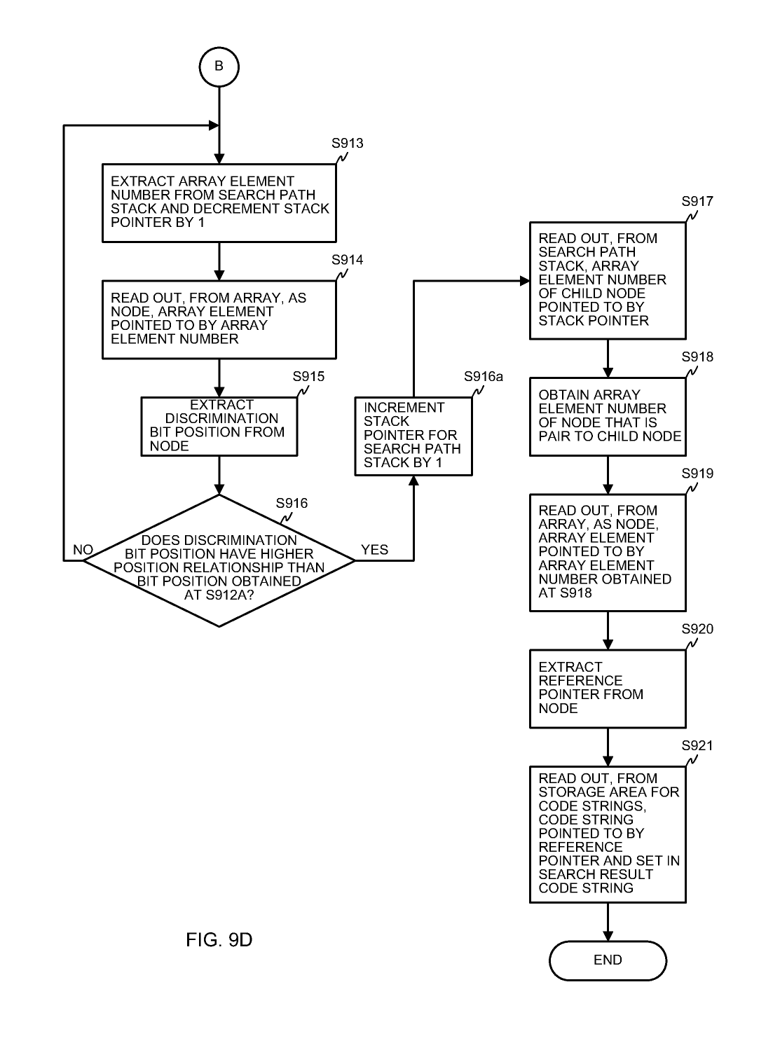

Next, proceeding to step S606, a longest prefix match search is executed to obtain the longest prefix matching key by means of the encoded search key and processing is terminated. This longest prefix match search processing is the processing to obtain the longest index key that prefix-matches the encoded search key from among the index keys corresponding to the code strings referenced by the reference pointer obtained as the search result of the initial search processing and the reference pointers stored in the code string terminus nodes that are pairs to the code string linked nodes whose array element numbers are stored in search path stack 310, in other words, it is the processing to obtain the longest prefix matching key. Details of the processing in step S606 are described hereinafter referencing FIG. 9A to FIG. 9D.

FIG. 7 is a drawing describing an example of the processing flow for the encoding process in one embodiment of the present invention. The encode processing in one embodiment of the present invention encodes the specified code string as shown in the example in FIG. 2, and generates the encoded code string while setting the encoded bit length.

This encode processing is the processing executed in step S602 of FIG. 6 and that executed in step S902 of FIG. 9B described hereinafter.

First, in step S701, the bit length of each code set in the code string (in the example shown in the above noted FIG. 2 this is “3”) is set in the code bit length.

Next, proceeding to step S702, the code position showing the position of the code to be processed next from among the codes in the code string is initialized. In one embodiment of this invention, in order to process the codes successively from the 0th code, the code position is initialized as “0”.

Then, in step S703, the storage position of the encoded code wherein is stored the encoded code of the encoded code string generated by this encode processing is set in the initial value.

Continuing, in step S704, a determination is made whether the code position is at the end of the code, in other words, whether the code pointed to by the code position is the code “*” that indicates the end of the end of the code string, and when it is not the code “*” that indicates the end of the end of the code string, processing proceeds to step S705 and when it is the code “*”, processing proceeds to step S709.

At step S705, the bit values in the code pointed to by the code position are extracted from the code string.

Then, at step S706a, the differentiating bit (in this example, “1”) that indicates the existence of a following code is set in the encoded code.

Next, at step S706b, the bit values of the code obtained at step S705 are appended to the end of the encoded code. Continuing, at step S707, the encoded code to which a bit value is appended at step S706b is stored in the position pointed to by the encoded code storage position in the encoded code string.

Then, at step S708a, the code position is advanced to the next code position, and at step S708b, the storage position of the encoded code is advanced to the next storage position for the encoded code, and processing returns to step S704. In the example shown in FIG. 2, the next storage position for the encoded code is the sum of the 1 bit width for the differentiating bit and the 3 bit width for the code bit length, making an advance of 4 bits.

When the determination at step S704 is that the code position at the end of the code string, processing proceeds to step S709, wherein the differentiating bit (in this example, “0”) that indicates the end of the code is stored in the position pointed to by the encoded code storage position for the encoded code string.

Then, at step S710 the encoded code storage position is set in the encoded bit length, and processing is terminated. By means of the above processing, an encoded code string encoded by the encoding method shown in FIG. 2 and its encoded bit length can be obtained from the specified code string.

Also, as was noted above, the encode processing shown in FIG. 7 is an encode processing common to each kind of code strings, and it is used to encode a code string, such as the search key, set in the code string which is a temporary storage area and to set it in the encoded code string. However, it is clear that the processing flow shown in FIG. 7 can be made to be a processing flow that enables the encoding of a particular code string by means of making the code string and the encoded code string that are temporary storage areas to be those for the particular code string. The insertion code string and encoded insertion key used in the insertion processing described hereinafter, and the deletion code string and encoded deletion key are those examples.

Although all the codes configuring a code string are encoded in a batch according to this preferred embodiment of the invention as shown in the example in FIG. 7, the search key may also be sequentially encoded, in search processing, up to the extent of the discrimination bit position in each of the branch nodes on the search path, if the code string that is the search key is relatively longer than the search target code strings.

Next, an initial search in one embodiment of the present invention is described referencing FIG. 8A and FIG. 8B.

FIG. 8A is a drawing showing conceptually the flow for the initial search using an encoded search key.

FIG. 8A depicts the encoded search key 270, one part of coupled-node tree 200 shown in FIG. 3, and search path stack 310.

Encoded bit string “1001101111010” (hereinafter this may at times be called encoded search key 70) which is the encoded search key (ACE*) that encodes the search key “ACE*” is stored in the encoded search key 270.

The parts below node 211c in coupled-node tree 200 are omitted, and the search path for the initial search from root node 210a using the encoded search key 70 is shown by the bold boxes and bold arrows.

In the initial search, first the array element number 220 for the root node 210a is set as the search start node. The value of the discrimination bit position 230a in root node 210a is “0”, and because the bit value at bit position 0 in encoded search key 70 is a “1” a link is made to node 211b which is the node on the [1] side of node pair 201b. Also, because the value “0” in discrimination bit position 230a for root node 210a matches one of the bit positions 0, 4, 8, . . . wherein reside the differentiating bits of encoded bit string 70, in other words, because the root node is a code string delimiter branch node, the array element number 220 of root node 210a (parent node) and the array element number 220a+1 for node 211b on the [1] side, which, of the two child nodes of root node 210a, is the code string linked node, are stored in search path stack 310.

Next, because the value for discrimination bit position 231b is “2” and the bit value at bit position 2 in encoded search key 70 is “0”, a link is made to node 210c, which is the node on the [0] side of node pair 201c. Because the value of the discrimination bit position 231b in node 211b is “2” and that does not match one of the bit positions wherein reside differentiating bits of encoded bit string 70, the array element number of this node is not stored in search path stack 310.

Next, because the value at discrimination bit position 230c in node 210c is “4” and the bit value at bit position 4 in encoded search key 70 is “1”, a link is made to node 211d, which is the node on the [1] side of node pair 201d. Because the value “4” in discrimination bit position 230c for node 210c matches one of the bit positions wherein reside the differentiating bits of encoded bit string 70, node 210c is a code string delimiter branch node noted above. Thus the array element number 221b of node 210c (parent node) and the array element number 220c+1 for the node 211d that is on the [1] side for the two child nodes of node 210c are stored in search path stack 310.

Next because the value at discrimination bit position 231d in node 211d is “8” and the bit value at bit position 8 in encoded search key 70 is “1”, a link is made to node 211e, which is the node on the [1] side for node pair 201e. Because node 211d is a code string delimiter branch node, the array element number 220c+1 for node 211d (parent node) and the array element number 221d+1 for the node 211e that is on the [1] side for the two child nodes of node 211d are stored in search path stack 310.

The value for the node type 261e in node 211e is “1”, indicating that node 211e is a leaf node. At this point the initial search finishes by extracting the reference pointer 281e stored in reference pointer 251e.

As shown in the drawing, the code string “ABEAB*” is stored in the storage area pointed to by reference pointer 281e. The bit expression for the encoded code string that encodes code string “ABEAB*” is “1001101011011 . . . ”.

Storing, in search path stack 310, the array element numbers for the code string delimiter branch nodes (parent nodes) and the array element numbers for whichever of the child nodes of that branch node is a code string linked node in the initial search noted above, is done in order to find the code string terminus child nodes (the leaf nodes noted above) for the code string delimiter branch nodes traversed during the initial search and to read out the code strings pointed to by those reference pointers in the longest prefix match search that follows.

In the example of the initial search shown in FIG. 8A, code string terminus nodes are, moving from the lowest levels in the coupled-node tree 200, node 210e, node 210d, and node 210b. Because the nodes on the [0] side and the nodes on the [1] side are disposed in adjacent storage areas, the array element numbers of code string terminus nodes can be obtained from the array element numbers of the code string linked nodes stored in the search path stack. Of course, by storing the array element numbers of the code string terminus nodes in the search path stack instead of the array element numbers of code string linked nodes, the array element numbers of the code string terminus nodes can be obtained directly.

Also, instead of the array element numbers of code string linked nodes or code string terminus nodes, the code string terminus node itself, which is a leaf node, could also be stored, or the reference pointer, or the code string related to the leaf node could also be stored. In other words, it is sufficient to store information related to the parent node and information for accessing the code string related to the code string terminus child node.

Next the processing flow for an initial search is described. FIG. 8B is a drawing showing the details of the processing in step S605 in FIG. 6 noted above and it describes an example of the processing flow for an initial search using an encoded search key. First, in step S801, an initial value is set in the value for the stack pointer to search path stack 310. This initial value is the value for when nothing is stored in search path stack 310. The stack pointer in the processing in FIG. 8B of this preferred embodiment of the invention is taken to indicate the position on search path stack 310 for storing the next array element number in step S813 noted below in the description hereinbelow.

Continuing, at step S802, the array element number of the search start node is set in the array element number. Because the processing executed in FIG. 8B occurs after step S604 in FIG. 6 is executed, at step S802, array element number of the root node is actually set.

Next, at step S803, the array element pointed to by the array element number is read out, as a node, from the array holding the nodes of the coupled-node tree. Then, at step S804, the node type information is extracted from the node read out at step S803, and at step S805, a determination is made whether that node is a branch node.

If the determination at step S805 is that the read-out node is a branch node (node type is “0”), processing proceeds to step S806, and information about the discrimination bit position is extracted from that node.

Then, at step S807, the bit value corresponding to the extracted discrimination bit position in the encoded search key is extracted, and at step S808, coupled node indicator information is extracted from that node.

Continuing, at step S811, a determination is made whether the discrimination bit position extracted at step S806 coincides with any of the positions wherein resides a differentiating bit in the encoded bit string. This determination, in accordance with the naming convention noted hereinabove, is the determination whether the node read out at step S803 is a code string delimiter branch node.

Also, as was noted above, the position of the differentiating bit depends on the encoding method. Although the position of the differentiating bit can be determined by computation and so forth in the case of a fixed length code, as shown in the example in the above noted FIG. 2, in the case of a variable length code, it is also possible to use a method for searching, using the discrimination bit position, a bit map that maps the positions of the differentiating bits and the variable length codes, and other similar art.

If the result of the determination in step S811 is that the discrimination bit position is a differentiating bit position, processing proceeds to step S812 in order to determine whether there is a following bit included in the encoded search key (a bit corresponding to a significant code), and a determination is made whether the bit value of the differentiating bit extracted at step S807 is a “1”.

If the bit value for the differentiating bit is “1”, that indicates that a bit having a value corresponding to a significant code exists in the bit position lower in the encoded search key than the discrimination bit position.

In this case, processing proceeds to step S813, and the array element number of the node read out at step S803 is stored in search path stack 310 as the array element number of the parent node.

Continuing, at step S814, the value computed by adding the value 1 to the coupled node indicator extracted at step S808 is set as the new array element number. Then, at step S815, the array element number obtained at step S814 is stored in search path stack 310 as the array element number of the child node, and, after incrementing the stack pointer by one, processing returns to step S803.

Also, the expression here of “incrementing by 1” is an expression arranged to match a description that illustrates an example wherein the search path stack 310 is divided into two columns, as shown in the example in FIG. 8A, and it is not intended to restrict the actual implementation method for the search path stack 310 and stack pointer.

In other words, the storage place, in the search path stack 310 in this preferred embodiment of the invention, specified by a single value of the stack pointer, holds a set of two array element numbers consisting of the array element number of a code string delimiter branch node and the array element number of the code string linked node, which is one of the child nodes of that code string delimiter branch node.

Also, regarding the processing of step S815, instead of the array element number obtained at step S814, an implementation variation wherein the coupled node indicator extracted at step S808 can be stored in search path stack 310 as the array element number for the child node, in other words, as was noted hereinabove, the array element number for the code string terminus node can also be stored in search path stack 310 as the array element number for the child node.

Also other implementation variations are also possible, such as storing in the search path stack 310 the code string terminus node itself, or the reference pointer extracted from the code string terminus node, or the code string pointed to by the reference pointer.

Regardless, the processing of step S815 is the processing to store in the search path stack information for accessing the search target code string related to the code string terminus node.

Conversely, if the determination at step S811 is that the discrimination bit position is not the position of a differentiating bit, or if the determination at step S811 is that the discrimination bit position is the position of a differentiating bit but the determination at step S812 is that the value of the differentiating bit at the discrimination bit position is a “0”, in either case, processing proceeds to step S809, wherein the bit value extracted from the encoded search key at step S807 is added to the coupled node indicator extracted at step S808 and the result of that addition is set as a new array element number and processing returns to step S803.

Thereinafter, the processing loop of step S803 to step S815 is repeated until the determination at step S805 is that of a leaf node. In this processing loop, the array element number set at step S809 or at step S814 is used at step S803.

If the determination in step S805 is that the node readout at step S803 is not a branch node, in other words, if the determination is that of a leaf node (node type is a “1”), processing proceeds to step S810, wherein the reference pointer included in that leaf node is extracted and processing is terminated.

As described above, in accordance with an initial search in this preferred embodiment of the invention, a coupled-node tree is searched using an encoded search key until a leaf node is reached, the reference pointer stored in the leaf node is read out, and at the same time, the array element numbers of the code string delimiter branch nodes traversed in that search and the array element numbers of their code string linked child nodes are successively stored in search path stack 310.

Next a longest prefix match search related to one embodiment of this invention is described referencing FIG. 9A to FIG. 9D.

FIG. 9A is a drawing showing conceptually the processing flow for a longest prefix match search. FIG. 9A depicts, the same as FIG. 8A, the coupled-node tree 200, the encoded search key 270 and search path stack 310, and it shows conceptually the flow of a longest prefix match search after the initial search shown in the example in FIG. 8A is finished.

As shown in FIG. 9A. in the encoded search key 270 is stored the encoded search key 70, which encodes the search key “ACE*”, which is the same bit string as the encoded search key shown in FIG. 8A. In search path stack 310 are stored the same array element numbers of code string delimiter branch nodes and code string linked nodes as in FIG. 8A. However, the stack pointer, shown by the arrow with bold lines, points to the array element number related to node 210c, which position is the position decremented by one from the position of the end of the initial search.

The parts below node 211c in coupled-node tree 200 are omitted, just like in FIG. 8A. The initial search reached node 211e and, in a discrimination bit position search back from node 211e, branch node 210c, which is the code string delimiter branch node, is reached, and the search path that determines that the index key related to the leaf node 210d, which is the code string terminus node for branch node 210c, is the longest prefix matching key is shown by bold boxes and arrows.

In the longest prefix match search, first, the encoded bit length of the index key (ABEAB*) that encodes the search target code string “ABEAB*” and which is obtained in the initial search is compared with the encoded bit length of the encoded search key (ACE*). In the example noted above, the encoded bit length of the index key (ABEAB*) is 20, and the encoded bit length of the encoded search key (ACE*) is 12. Thus because the encoded bit length of the index key is longer than the encoded bit length of the encoded search key, the code string “ABEAB*” does not prefix-match the search key “ACE*”.

At this point, next, the array element number 221d+1 for the child node on the [1] side pointed to by stack pointer at the end of the initial search is extracted from search path stack 310, and from that array element number the child node on the [0] side, in other words, array element number 221d for the code string terminus child node 210e is obtained and node 210e is read out. Then the code string “AB*” is read out via the reference pointer from node 210e, and the (AB*) that encodes that code string is taken to be a new index key and the encoded bit length of that index key is compared with the encoded bit length of the encoded search key (ACE*).

When this is done, because the encoded bit length of the index key (AB*) is 8 and that is shorter than the encoded bit length 12 of the encoded search key (ACE*), thereinafter, by means of the relative position relationship between the difference bit positions between the index keys and the encoded search key and the discrimination bit positions of the parent nodes for the code string terminus child nodes related to those index keys, a code string terminus child node is identified and the code string pointed to by the reference pointer in the identified code string terminus child node is taken to be the longest prefix matching key.

In other words, the array element numbers of the parent nodes are successively read out from the search path stack and the discrimination bit positions are extracted from the code string delimiter branch node disposed in the array elements pointed to by those array element numbers. Then, if that discrimination bit position coincides with the above noted difference bit positions or has a higher position relationship, the code string pointed to by the reference pointer in the code string terminus child node for that code string delimiter branch node is taken to be the longest prefix matching key.

The discrimination bit position search shown by the arrows with bold lines in FIG. 9A shows the processing flow to search for a discrimination bit position which has a position relationship that is equal to or higher than the above noted difference bit positions.

Also, the determination of the longest prefix matching key shown by the arrows with bold lines in FIG. 9A is the processing flow that makes the code string pointed to by the reference pointer in the code string delimiter branch node whose discrimination bit position has the above noted position relationship with respect to the difference bit position to be the longest prefix matching key.

In the example shown in FIG. 9A, the difference bit position between index key (AB*) and encoded search key (ACE*) is 7, and array element number 220c+1, which is the array element number of the parent node first read out from search path stack 310, is the array element number for branch node 211d. Because the value for the discrimination bit position 231d in branch node 211d is “8” and that value has a position relationship lower than the difference bit position “7”, the array element number 221b is read out from search path stack 310 as the next array element number of a parent node. Because the value for the discrimination bit position 230c in branch node 210c disposed in the array element pointed to by array element number 221b is “4” and that value has a position relationship higher than the difference bit position “7”, the code string “A*” pointed to by the reference pointer 280d in the code string terminus child node 210d for branch node 210c is the longest prefix matching key.

Next, why the longest prefix matching key obtained by the above noted method is the longest code string that prefix-matches the search key, of all the search target code strings, is described.

First, terms are defined for the description hereinbelow.

In the initial search, the code strings related to the code string terminus child nodes for the code string delimiter branch nodes whose array element numbers are stored in the search path stack as the array element number of a parent node are called code strings in the search path for the initial search. In the example shown in FIG. 8A, the code strings in the search path for the initial search are “*”, “A*”, and “AB*”.

Thus, as was noted above, the code strings in the search path for the initial search prefix-match the code strings related to the leaf nodes disposed at levels lower than the code string linked child nodes paired with those code string terminus child nodes related to those code strings. Also, the lengths of the code strings in the search path for the initial search are shorter than the lengths of the code strings related to the leaf nodes disposed at levels lower than the code string linked child nodes paired with those code string terminus child nodes related to those code strings.

If the search result key for the initial search prefix-matches the search key, the code strings in the search path for the initial search prefix-match the search key because they prefix-match the search result key but their lengths are equal to or less than the length of search result key. Then, by the special properties of the coupled-node tree related to this invention, no other code strings that prefix-match the search key, other than the code strings in the search path for the initial search, are stored in the coupled-node tree. Thus, if the search result key for the initial search prefix-matches the search key, that search result key is the longest prefix matching key.

Next, if the search result key for the initial search does not prefix-match the search key and a code string that prefix-matches the search key is stored in the coupled-node tree, then that code string is included among the code strings in the search path for the initial search. Thus, the longest code string of all the code strings in the search path that prefix-match the search key is the longest prefix matching key.

For that reason, the longest prefix matching key obtained by the above noted method is the longest code string that prefix-matches the search key, of all the search target code strings.

Next, the processing flow for a longest prefix match search based on the results of an initial search is described referencing FIG. 9B to FIG. 9D, which show details of the processing in step S606 of FIG. 6.

FIG. 9B is a drawing describing an example of the processing flow for the first stage of a longest prefix match search. The processing of the first stage, shown in FIG. 9B, is the processing to eliminate from the processing in FIG. 9C and thereafter index keys that do not prefix-match the encoded search key by starting from the search result code string for the initial search which encodes an index key, and successively renewing the index keys to those with a shorter encoded bit length and making the encoded bit lengths of the index keys equal to or less than the encoded bit length of the encoded search key.

As shown in FIG. 9B, first, at step S901, the code string pointed to by the reference pointer is read out from the code string storage area and is set in the code string. In the first-time processing of step S901, the reference pointer is the one obtained in the initial search of step S605 shown in FIG. 6. In the example shown in FIG. 8A and FIG. 9A, the reference pointer 281e is obtained and the code string “ABEAB*” is read out.

Next, proceeding to step S902, encode processing is performed wherein the code string set at step S901 is encoded using the encoding method described using FIG. 2, and an encoded code string is generated, and information about the encoded bit length of that encoded code string is obtained. Details of the encode processing were described referencing FIG. 7.

Next, in step S903, the encoded code string generated at step S902 is set in the index key and the encoded bit length of the encoded code string obtained at step S902 is set in the encoded bit length of the index key. In the example shown in FIG. 9A, in the first-time processing of step S902 and step S903, (ABEAB*), in other words, “100110101101100110100”, is set in the index key and 20 is set in the encoded bit length of the index key.

The processing of the above noted step S901 and step S903, the same as for the processing in step S601 and step S603 in FIG. 6, is the processing to apply to the index key the same kind of encode processing applied to the search key for each of the various code strings shown in FIG. 7. Just as for the case in FIG. 6, instead of using the shared encode processing shown in FIG. 7, the processing shown in FIG. 7 can also be changed to a special code string encoding for encode processing of the index key.

Also, the code string set in the first-time processing of step S901 may at times be called the search result code string for the initial search. Also, the index key set in the first-time processing of step S902 and step S903 may at times be called the index key obtained in the initial search.

Next, in step S904, a determination is made whether the encoded bit length of the index key is equal to or less than the encoded bit length of the encoded search key. Here, the encoded bit length of the encoded search key is the one set at step S603 shown in FIG. 6. In the example shown in FIG. 9A, the encoded bit length of the encoded search key (ACE*) is 12.

If the encoded bit length of the index key is not equal to or less than the encoded bit length of the encoded search key index key, in other words, if the number of codes in the search target code string before encoding is larger than the number of codes in the search key, that search target code string does not prefix-match the search key.

Whereat, when the determination at step S904 is negative, the processing of step S905 to step S909 is done and processing returns to step S901, and the successive access to the code strings in the search path for the initial search is repeated until the determination at step S904 is positive.

At step S905, the array element number for the child node pointed to by the stack pointer is read out from the search path stack, and at step S906, the stack pointer for the search path stack is decremented by one.

Next, at step S907, the array element number that is paired with the array element number for the child node read out above is obtained. Then, proceeding to step S908, the array element pointed to by the array element number obtained at step S907 is read out, as a node, from the array holding the nodes of the coupled-node tree.

Continuing, at step S909, the reference pointer is extracted from the node read out at step S908, and processing returns to step S901. In the second-time and thereafter processing of step S901, the reference pointer is the one extracted at step S909.

If, in the initial search, the array element number of a code string terminus node is stored in the search path stack as the array element number of a child node, the above noted step S907 is unnecessary, and at step S908, the array element pointed to by the array element number obtained at step S905 is then read out as a node.

Also, if, in the initial search, the code string terminus node is stored in the search path stack, in step S905, the code string terminus node pointed to by the stack pointer is read out from the search path stack, and step S907 and step S908 are skipped, and in step S909, the reference pointer is extracted from the code string terminus node read out at step S905 and processing then returns to step S901.

Furthermore, it is clear to one skilled in the art, from the above description, how the processing flow in FIG. 9B would change if, in the initial search, the reference pointer or the search target code string is stored in the search path stack.

When the determination at step S904 becomes positive in the above noted processing loop of step S901 to step S909, processing moves to step S910 shown in FIG. 9C.

In the example shown in FIG. 9A, because the encoded bit length of the index key at the first time the determination is made in step S904 is 20 and the encoded bit length of the encoded search key is 12 the determination is negative. Thus, the code string “AB*” on the search path of the initial search is read out by means of the processing of step S905 to step S909 and step S901. Because the encoded bit length of the index key (AB*) that encodes that code string is 8, the determination at step S904 the second time becomes positive, and processing proceeds to step S910 in FIG. 9C. The stack pointer for search path stack 310 points to array element number 221b by the processing of step S906.

FIG. 9C is a drawing describing an example of the processing flow for the middle stage of a longest prefix match search. The processing of the middle stage, shown in FIG. 9C, is the processing wherein the bit strings of the encoded search key and the index key are compared within the range of the encoded bit length of the index key, which index key is determined to have an encoded bit length equal to or less than the encoded bit length of the encoded search key in the initial processing, shown in FIG. 9B, and if they coincide, the code string encoded in the index key is made the longest prefix matching key, and if they do not coincide, a difference bit position between the encoded search key and the index key is obtained within the range of the above noted encoded bit length.

As shown in FIG. 9C, first in step S910, the encoded bit length of the index key is set in the comparison bit length. In the example shown FIG. 9A, in step S910, the value 8, which is the encoded bit length of the index key (AB*), is set in the comparison bit length.

Then, at step S911, a determination is made whether the bit values of the encoded search key and the index key coincide within the range of the comparison bit length. This is equivalent to a determination whether the search key and the search result code string coincide with the range of the length of the search result code string. If the result of this determination is that the encoded search key and the index key coincide within the range of the comparison bit length, in other words, within the encoded bit length of the index key, processing proceeds to step S911a, and the code string encoded in that index key is set in the search result code string and processing is terminated. That search result code string is the code string that matches the search key the longest.

Conversely, when the result of the determination at step S911 is that the encoded search key and the index key do not coincide within the range of the comparison bit length, processing proceeds to step S912.

At step S912, a bit comparison is done between the encoded search key and the index key within the range of the comparison bit length and a difference bit string for the length of the comparison bit length is obtained. The difference bit string consisting of, for example, values for a bit at a position where the value in the encoded search key and the index key coincide is a “0” and the values for a bit at a position that does not coincide is a “1”, and this can be obtained, for example, by an exclusive OR operation between the encoded search key and the index key.

Continuing, at step S912a, the highest position in the difference bit string, in other words, the bit position of the first non-coinciding bit, seen from the 0th bit, is set in the difference bit position, and processing proceeds to the processing in step S913 and thereafter shown in FIG. 9D. The processing in step S912a can be done, for example, by inputting that difference bit string into a CPU with a priority encoder and obtaining the non-coinciding bit position, or performing in software the same kind of processing as a priority encoder and obtaining the bit position of the first non-coinciding bit.

In the example shown in FIG. 9A, because the bit value for the bit string pointed to by the comparison bit length 8 for the encoded search key (ACE*) is (AC), and the bit value for the bit string pointed to by the comparison bit length 8 for the index key (AB*) is (AB), the determination in step S911 is negative. Then, “7” is set in the difference bit position.

FIG. 9D is a drawing describing an example of the processing flow for the last stage of a longest prefix match search. The processing for the last stage, shown in FIG. 9D, is the processing wherein the longest prefix matching key is obtained by the relative position relationship between the difference bit position obtained in the processing for the middle stage shown in FIG. 9C and the discrimination bit positions in the code string delimiter branch nodes whose array element numbers are stored in the search path stack.

As shown in the drawing, in step S913, the array element number is extracted from the search path stack, and the stack pointer is decremented by one. Then, at step S914, the array element pointed by the array element number is read out from the array as a node, and in step S915, the discrimination bit position is extracted from the node.

Next, in step S916, a determination is made whether the extracted discrimination bit position has a higher position relationship than the difference bit position set at step S912a. Then, if the discrimination bit position has a higher position relationship than the difference bit position, processing proceeds to step S916a, and if it does not, processing returns to step S912. In other words, when the discrimination bit position included in the node with the array element number extracted from search path stack 310 does not have a higher position than the difference bit position, a processing loop is executed to traverse the search path stack and extract array element numbers until a node whose discrimination bit position has a higher position relationship than the difference bit position is read out. This processing loop is equivalent to the difference bit position search shown in the example in FIG. 9A.

Because, in the example shown in FIG. 9A, the stack pointer for search path stack 310 points to array element number 221b by the processing in the previous step S906, at step S914, branch node 210c is read out, and at step S915, the discrimination bit position “4” is extracted. Because the extracted discrimination bit position “4” has a higher position than the difference bit position “7” set at step S912a, the result of the determination at step S916 becomes “yes” and processing proceeds to step S916a.

At step S916a, the previous status is returned by incrementing by 1 the stack pointer for the search path stack that has been decremented at step S913, and at step S917, the array element number of the child node pointed to by the stack pointer for the search path stack is read out.

Then, at step S918, the array element number of the node that is a pair with the array element number of that child node is obtained, and at step S919, the node pointed to by the array element number of the node comprising that pair is read out.

Then, at step S920, the reference pointer is extracted from that node, and at step S921, the code string pointed to by the reference pointer is read out from code string storage area 311 and is set in the search result code string.

In the example shown in FIG. 9A, in step S916a, the stack pointer for search path stack once again points to the array element number of the parent node 221b, and at step S917, the array element number 220c+1 for the child node pointed to by the stack pointer is read out. Then, in the processing from step S918 to S921, node 210d is read out, and code string “A*” that is pointed to by the reference pointer 280d is set in the search result code string. The processing of step S916a to step S921 is equivalent to the longest prefix matching key determination shown in the example in FIG. 9A.

Also, if, in the initial search, the array element number of the code string terminus node is stored in the search path stack as the array element number of the child node, the processing of the above noted step S918 is unnecessary and at step S919, the array element pointed to by the array element number obtained at step S917 is read out as a node.

Also, if, in the initial search, the code string terminus node is stored in the search path stack, in step S917, the code string terminus node pointed to by the stack pointer is read out from the search path stack, and steps S918 and step S919 are skipped, and in step S920, the reference pointer is extracted from the code string terminus node read out at step S917. Furthermore, it is clear to one skilled in the art, from the above description, how the processing flow in FIG. 9D would change if, in the initial search, the reference pointer or the search target code string is stored in the search path stack.

Next, we describe how a search result key can always be obtained by making the coupled-node tree also include a code string comprised only of the terminal code “*”, even for searches using any kind of a search key.

When an initial search is executed using an encoded search key that encodes any arbitrary search key and then a longest prefix match search is performed, after the processing shown in FIG. 9B, in step S910 shown in FIG. 9C, the encoded bit length of a given index key is set in the comparison bit length. If the bit strings within the range of the comparison bit length for the encoded search key and the index key coincide, as shown in FIG. 9C, a search result key is obtained.

Conversely, if the bit values for the bit strings within the range of the comparison bit length for the encoded search key and the index key do not coincide, as shown in FIG. 9C, a difference bit position is obtained. Then, the processing of step S913 to step S916 shown in FIG. 9D is reached, and a discrimination bit position search is executed.

Now, from the fact that the coupled-node tree includes a code string consisting only of the terminal code “*”, the root node is a code string delimiter branch node, and its discrimination bit position is 0. Also, as long as the search key consists of significant codes, the above noted difference bit position is a position lower than 0. Thus, because the determination in step S916 of FIG. 9D is guaranteed to become positive at some point, a code string is always set in the search result code string in step S921.

If the coupled-node tree is made so that it does not include a code string consisting only of the terminal code “*”, for a longest prefix match search in that case it is sufficient to insert in the processing loop of FIG. 9B and FIG. 9D a determination whether the stack pointer for the search path stack points to the initial value, and if the points stack pointer points to the initial value, to make that a search failure.

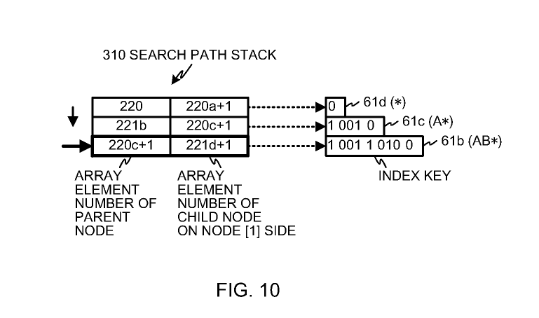

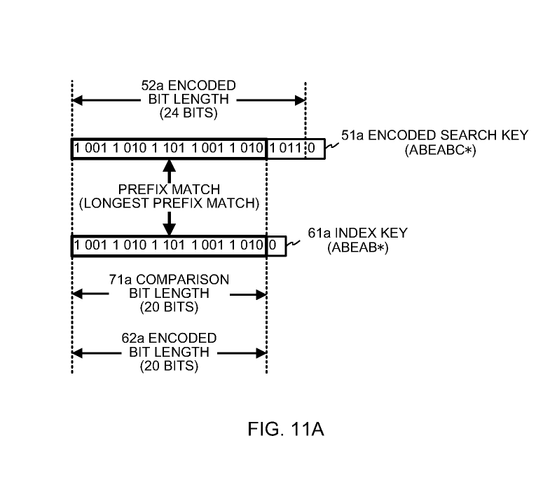

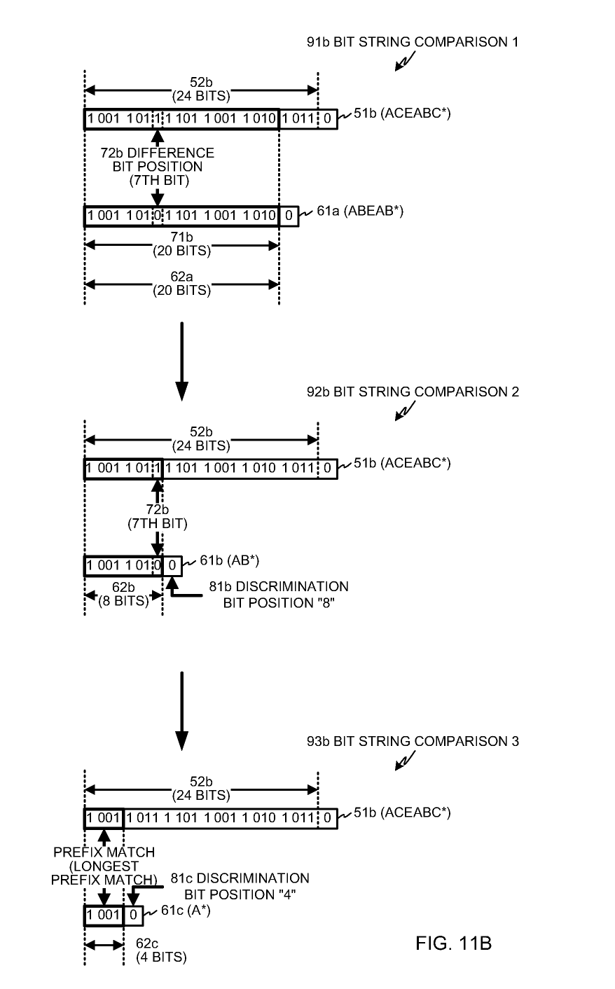

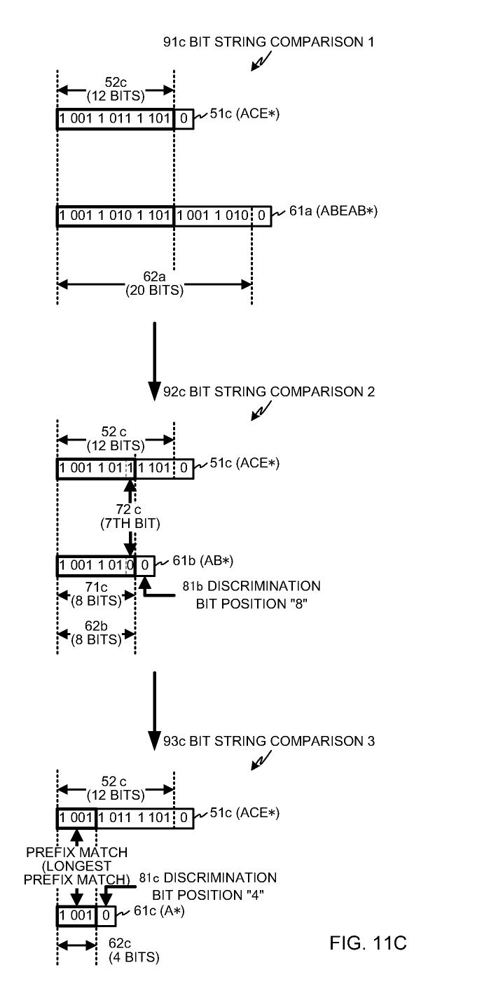

Hereinabove, details of a preferred embodiment related to a longest prefix match search in this invention were described. Hereinbelow, a concrete example of a longest prefix match search is described, referencing FIG. 10 and FIG. 11A to FIG. 11C, in order to further facilitate an understanding of a longest prefix match search in this invention.

The coupled-node tree in the concrete example described hereinbelow is the one shown in the example in FIG. 3. Three types of encoded search keys are exemplified. In the example shown in FIG. 11A, (ABEABC*) is used as the encoded search key. In the examples shown in FIG. 11B and FIG. 11C (ACEABC*) and (ACE*) are used respectively as the encoded search keys. The result of an initial search using each of these encoded search keys is the same as that shown in the example in FIG. 9A.

FIG. 10 is a drawing describing an example of the data stored in the search path stack 310 and its relation to the index keys related to the code string terminus child nodes.

In search path stack 310 are stored array element numbers, the same as those shown in FIG. 9A, which are the results of an initial search using the encoded search keys shown in the examples in FIG. 11A, FIG. 11B, and FIG. 11C.

As shown in FIG. 10, first, array element number 220 and array element number 220a+1 are stored in search path stack 310 as the array element number of the parent node and the array element number of the child node on the [1] side. As shown by the arrow with a dotted line, the index key (*) with the reference label 61d corresponds to array element number 220a+1. When array element number 220a+1 is read out at step S905 shown in FIG. 9B, then at step S903, (*), in other words, “0” is set in the index key.

Next, as shown by the downward-pointing arrow, array element number 221b and array element number 220c+1 are stored in search path stack 310, followed by array element number 220c+1 and array element number 221d+1.

As shown by the arrows with dotted lines from each of these, the index key (A*) with the reference label 61c corresponds with array element number 220c+1, and when at step S905 shown in FIG. 9B array element number 220c+1 is read out, in step S903, (A*), in other words, “10010”, is set in the index key; and the index key (AB*) with the reference label 61b corresponds with array element number 221d+1, and when at step S905 shown in FIG. 9B array element number 221d+1 is read out, in step S903, (AB*), in other words, “100110100”, is set in the index key. Also, as shown by the arrow with the bold line, the stack pointer points to the array element number of the parent node, 220c+1.

FIG. 11A is a drawing describing conceptually an example of a longest prefix match search when the index key obtained at the initial search prefix-matches the encoded search key. As was noted above, encoded search key 51a is (ABEABC*), which encodes the search key “ABEABC*”.

In a bit expression it becomes “1001101011011001101010110” and its encoded bit length 52a is 24 bits.

When an initial search is executed with this encoded search key 51a using the coupled-node tree 200 shown in FIG. 3, because the value of the 0th bit in encoded search key 51a is a “1”, the value of the 2nd bit is a “0”, the value of the 4th bit is a “1”, and the value of the 8th bit is a “1”, just as shown in the example in FIG. 8A, the reference pointer 281e pointing to the storage area wherein is stored the code string “ABEAB*” is extracted from node 211e as the result of this initial search and the contents shown in FIG. 10 are stored in search path stack 310.

Then, in the first-time processing of step S901 to step S903 in the longest prefix match search shown in FIG. 9B, the code string “ABEAB*” is read out and is encoded into the index key (ABEAB*) shown with the reference label 61a, while 20 bits are set in the encoded bit length 62a of the index key, as shown in FIG. 11A.

Continuing, in step S904, a magnitude comparison is made between the encoded bit length 62a of the index key and the encoded bit length of the encoded search key 52a, and because the encoded bit length 62a is equal to or smaller than the encoded bit length of the encoded search key 52a, the encoded bit length 62a of the index key is set in the comparison bit length 71a.

Then, as shown in FIG. 11A, at step S911a determination is made that the bit values of encoded search key 51a and index key 61a coincide within the range of the comparison bit length 71a, in other words, that index key 61a prefix-matches the encoded search key. Continuing, at step S911a, the code string “ABEAB*” that is encoded into index key 61a is set in the search result code string as the longest prefix matching key. As was described above, if the search result key for the initial search prefix-matches the search key, the search result key is the longest prefix matching key.

FIG. 11B is a drawing describing conceptually an example of a longest prefix match search when the encoded bit length of the index key obtained at the initial search is shorter than the encoded bit length of the encoded search key.

As was noted above, encoded search key 51b is (ACEABC*), which encodes the search key “ACEABC*”. In a bit expression it becomes “1001101111011001101010110” and its encoded bit length 52b is 24 bits.

As shown in FIG. 11B, in a longest prefix match search using encoded search key 51b, the longest prefix matching key is obtained by performing the bit string comparisons 1, 2, and 3 shown with the reference labels 91b, 92b, and 93b.

Because the value of the 0th bit, the 2nd bit, the 4th bit, the 8th bit in encoded search key 51b coincide with the values at those respective positions in encoded search key 51a, the result of the initial search is the same as the result for an initial search using encoded search key 51a. Thus, just as in the example shown in FIG. 11A, in an initial search and in the first-time processing of step S901 to step S903 of the longest prefix match search shown in FIG. 9B, the code string “ABEAB*” is read out and is encoded into the index key (ABEAB*) shown with the reference label 61a, while 20 bits are set as the encoded bit length 62a for the index key, as shown in bit string comparison 1 (91b) of FIG. 11B. Also the encoded bit length 62a for the index key is set in the comparison bit length 71b.

In bit string comparison 1 (91b), the determination at step S911 is that the bit values in encoded search key 51a and index key 61a do not coincide within the range of comparison bit length 71b, and the bit position of the 7th bit is set in the difference bit position 72b by the processing of step S912 to step S912a.

Next, by means of the processing loop of steps S913 to S916 shown in FIG. 9D, a discrimination bit position search is performed to obtain the array element number for a code string delimiter branch node with a discrimination bit position that is a position higher than the difference bit position. First, the code delimiter branch node 211d for array element number 220c+1, which has been last stored and pointed to by the stack pointer, is read out, and the value “8” in its discrimination bit position 231d is extracted, and the bit string comparison 2 (92b) shown in FIG. 11B is performed.

The bit string comparison 2 (92b) shows encoded search key 51b and the index key (AB*) related to the code string terminus child node for the code delimiter branch node 211d and shown with the reference label 61b. The bit expression for index key 61b is “100110100”, and its encoded bit length 62b is 8 bits.

The bit string comparison 2 (92b) depicts an arrow showing which of the bit positions in encoded search key 51b and index key 61b is the bit position corresponding to the difference bit position 72b and an arrow showing which of the bit positions in index key 61b has the value “8”, which is the bit position corresponding to discrimination bit position 81b.

In bit string comparison 2 (92b), it is determined that discrimination bit position 81b does not have a higher position relative to difference bit position 72b. Thus, as shown in the drawing, because, in the code string “AB*” (61b) in the search path for the initial search, the part that encodes significant codes located higher than the discrimination bit position 81b has a different value at difference bit position 72b than encoded search key 51b, the code string 61b does not prefix-match encoded search key 51b.

Then, the processing loop of steps S913 to S916 shown in FIG. 9D is repeated, and code delimiter branch node 210c with array element number 221b that has been stored by the stack pointer is read out, and the value “4” in its discrimination bit position 230c is extracted, and bit string comparison 3 (93b) shown in FIG. 11B is performed.

The bit string comparison 3 (93b) shows encoded search key 51b and the index key (A*) related to the code string terminus child node for the code delimiter branch node 210c and shown with the reference label 61c. The bit expression for index key 61c is “10010”, and its encoded bit length 62c is 4 bits.

The bit string comparison 3 (93b) depicts an arrow showing which of the bit positions in index key 61c has the value “4”, which is the bit position corresponding to discrimination bit position 81c, and an arrow showing that, in the index key 61c, the part that encodes significant codes located higher than discrimination bit position 81c prefix-matches encoded search key 51b.

In bit string comparison 3 (93b) a determination is made that discrimination bit position 81c has a higher position relationship than difference bit position 72b. Then, because the values in the bits in encoded search key 51b and index key 61c coincide at positions higher than difference bit position 72b, the part encoding significant codes located higher than discrimination bit position 81c in the code string “A*” (61c) in the search path for the initial search coincides with the part encoding significant codes located higher than discrimination bit position 81c in encoded search key 51b, and the index key 61c prefix-matches encoded search key 51b. Also, the index key 61c is the longest key among the keys that prefix-match encoded search key 51b and is the longest prefix matching key.

FIG. 11C is a drawing describing conceptually an example of a longest prefix match search when the encoded bit length of the index key obtained at the initial search is longer than the encoded bit length of the encoded search key.

As was noted above, encoded search key 51c is (ACE*), which encodes the search key “ACE*”. Its bit expression is “1001101111010”, and its encoded bit length 52c is 12 bit.

As shown in FIG. 11C, in a longest prefix match search using encoded search key 51c, the longest prefix matching key is obtained by performing the bit string comparisons 1, 2, and 3 shown with the reference labels 91c, 92c, and 93c.

Because the value of the 0th bit, the 2nd bit, the 4th bit, the 8th bit in encoded search key 51c coincide with the values at those respective positions in encoded search key 51a and encoded search key 51b, the result of the initial search is the same as the result for an initial search using encoded search key 51a and encoded search key 51b. Thus, just as in the examples shown in FIG. 11A and FIG. 11B, in an initial search and in the first-time processing of step S901 to step S903 of the longest prefix match search shown in FIG. 9B, the code string “ABEAB*” is read out and is encoded into the index key (ABEAB*) shown with the reference label 61a, while 20 bits are set as the encoded bit length 62a for the index key, as shown in bit string comparison 1 (91c) of FIG. 11C.

During bit string comparison 1 (91c), the determination at step S904 is that the encoded bit length 62a for index key 61a is longer than the encoded bit length 52c for encoded search key 51c.

Due to the determination at step S904, the processing of step S905 to step S909 is done and then once again the processing of step S901 to step S903 is done. As a result, the index key (AB*) related to the code string terminus child node 210e for the code delimiter branch node 211d with array element number 220c+1 that has been last stored by the stack pointer and its encoded bit length 62b are set, and bit string comparison 2 (92c) shown in FIG. 11C is performed.

The bit string comparison 2 (92c) shows encoded search key 51c and the index key (AB*) related to the code string terminus child node for the code delimiter branch node 211d and shown with the reference label 61b. The bit expression for index key 61b is “100110100”, and its encoded bit length 62b is 8 bits.

In bit string comparison 2 (92c), first, at step S904, a determination is made that the encoded bit length 62b for the index key 61b is shorter than the encoded bit length 62a for the encoded search key 51c. Then, the encoded bit length 62b for the index key 61b is set in the comparison bit length 71c by the processing in step S910.

Also, the bit string comparison 2 (92c) depicts the encoded search key 51c, an arrow showing which of the bit positions in index key 61b is the bit position corresponding to the difference bit position 72c, and an arrow showing which of the bit positions in index key 61b has the value “8”, which is the bit position corresponding to discrimination bit position 81b.

Then, in bit string comparison 2 (92c), it is further determined that discrimination bit position 81b does not have a higher position relative to difference bit position 72c. Thus, as shown in the drawing, because, in the code string “AB*” in the search path for the initial search, the part that encodes significant codes located higher than the discrimination bit position 81b has a different value at difference bit position 72c than encoded search key 51c, “AB*” does not prefix-match encoded search key 51c.

Then, the processing loop of steps S913 to S916 shown in FIG. 9D is executed, and code delimiter branch node 210c with array element number 221b that has been stored by the stack pointer is read out, and the value “4” in its discrimination bit position 230c is extracted, and bit string comparison 3 (93c) shown in FIG. 11C is performed.

As is clear from a comparison between the bit string comparison 3 (93c) shown in FIG. 11C and the bit string comparison 3 (93b) shown in FIG. 11B, the processing in bit string comparison 3 (93c) is the same as the processing in bit string comparison 3 (93b) shown in FIG. 11B. Thus this becomes repetitious and that description is omitted.

Next, the processing to insert, in accordance with the specification of an insertion key, a leaf node into a coupled-node tree related to one preferred embodiment of this invention is described referencing FIG. 12 to FIG. 13C. This insertion processing is similar to that disclosed in Patent Document 2 with the exception that the insertion key and the search target code strings are encoded. Also, just as for the art disclosed in Patent Document 2, because a coupled-node tree is generated by the processing to insert a root node and the ordinary insertion processing to insert nodes other than the root node in an already existing coupled-node tree, a description of the processing to insert a node is also a description of the processing to generate a coupled-node tree.

FIG. 12 is a drawing describing an example of the processing flow for generating a coupled-node tree in one embodiment of the present invention.

First, at step S1201, the pointer to the storage area wherein is stored the code string (insertion key) that is to be inserted in the coupled-node tree is obtained.

Continuing, in step S1202, a determination is made whether the array element number of the root node for the coupled-node tree has been registered. As was noted above, in one embodiment of this invention, the array element number of the root node for the coupled-node tree is registered in the management means for the coupled-node tree, and at this step S1202, a check is made whether the array element number of the root node has been registered. If the result is that it has been registered, processing proceeds to step S1203.

At step S1203, the insertion key stored in the storage area pointed to by the pointer obtained at step S1201 is set in the insertion code string, and next, in step S1203a, an encoded insertion key is generated from the insertion code string. The encode processing in step S1203a can be implemented by the processing flow shown in FIG. 7.

Next, proceeding to step S1204, the array wherein the coupled-node tree is stored is searched from the root node using the encoded insertion key, and the processing is performed to insert a leaf node that includes a reference pointer pointing to the area wherein is stored the insertion key, and this insertion processing is terminated. Details of the processing in this step S1204 are described hereinbelow referencing FIG. 13A to FIG. 13C.

Conversely, if the determination at step S1202 is that a root node is not registered, the registration and generation of a completely new coupled-node tree begins. In other words, proceeding to step S1205, an empty node pair is obtained from the array, and the array element number of the array element that shall be the primary node of that node pair is acquired.

Next, in step S1206, an array element number computed by adding the value “0” to the array element number acquired at step S1205 is obtained. (Because, in this preferred embodiment of the invention, the computed array element number obtained in this step is identical to the array element number acquired at step S1205, step S1206 can be omitted).

Continuing, in step S1207, the root node is inserted by writing a “1”, indicating a leaf node, in the node type of the array element with the array element number obtained at step S1206 and writing, in its reference pointer, the above noted pointer pointing to the storage area wherein is stored the insertion key acquired at step S1201.

Then, at step S1208, the array element number obtained at step S1206 is registered in the management means for the coupled-node tree as the array element number of the root node and the processing of FIG. 12 is terminated.

Next the processing of the above noted step S1204, in other words, the processing to insert, into an already-existing coupled-node tree, a leaf node holding a reference pointer pointing to the storage area wherein is stored the insertion code string, is described referencing FIG. 13A to FIG. 13C. FIG. 13A is a drawing describing an example of the processing flow for the first stage of insertion processing in one embodiment of the present invention. FIG. 13B is a drawing describing an example of the processing flow for the middle stage of insertion processing, which is the processing to prepare array elements for the node pair to be inserted, in one embodiment of the present invention. FIG. 13C is a drawing describing an example of the processing flow for the last stage of insertion processing, which is the processing to obtain the position for inserting the node pair, to write the contents for each node of the node pair, and to complete the insertion processing, in one embodiment of the present invention.

First, in step S1301 of FIG. 13A, the array element number of the root node is set in the array element number of the search start node. Then, at step S1302, the encoded insertion key generated in the above noted step S1203a is set as the encoded search key.

Next, proceeding to step S1310a, the array wherein the coupled-node tree is stored is searched from the root node using the encoded insertion key, and a reference pointer is obtained. This processing is realized by the basic search processing shown in FIG. 5.

Then, at step S1310b, the code string pointed to by the reference pointer obtained at step S1310a is read out from the code string storage area 311, and, at step S1310c, the read-out code string is encoded and an encoded bit string (index key) is generated. The encode processing in step S1310c can be realized by the processing flow shown in FIG. 7.

Next, in step S1311, a determination is made whether the encoded insertion key coincides with the index key generated at step S1310c. If the encoded insertion key and the index key coincide, the insertion fails because a leaf node related to a search target code string corresponding to the insertion key already exists in the coupled-node tree, and processing is terminated.

When the encoded insertion key and the index key do not coincide, processing proceeds to step S1312 in FIG. 13B.

In this step S1312, an empty node pair is obtained from the array, and the array element number of the array element that shall be the primary node of that node pair is acquired.

Next, proceeding to step S1313, a magnitude comparison is made between the encoded insertion key and the index key generated at step S1310c, and when the encoded insertion key is larger, a Boolean value of “1” (true) is obtained, and when it is smaller, a Boolean value of “0” (false) is obtained.

Then proceeding to step S1314, the Boolean value obtained at step S1313 is added to the array element number of the array element obtained at step S1312, obtaining an array element number. As is noted hereinbelow, the array element number obtained at this step S1314 becomes the array element number of the array element wherein is stored the leaf node holding the reference pointer pointing to the storage area holding the insertion key.

Continuing to step S1315, the value that is a bit inversion of the Boolean value obtained at step S1313 (logical negation value for the Boolean value) is added to the array element number of the primary node obtained at step S1312, obtaining an array element number. This array element number becomes the array element number of the array element wherein is stored the node that is the other pair to the leaf node holding the reference pointer pointing to the storage area holding the insertion key.

In other words, as a result of a magnitude comparison between the encoded insertion key and the index key obtained as an encoding of the code string referenced by the reference pointer stored in the leaf node obtained in the search processing shown in FIG. 13A, it can be decided which of the nodes of the node pair to be inserted is to be made the leaf node keeping the reference pointer pointing to the storage area holding the insertion key.

Next, processing proceeds to the processing of step S1316 and thereafter shown in FIG. 13C.

As shown in FIG. 13C, at step S1316, a bit string comparison is performed between the encoded insertion key and the index key generated at step S1310c, and a difference bit string is obtained. Next, proceeding to step S1317, the bit position of the first differing bit seen from the highest 0th bit is obtained from the difference bit string obtained at step S1316.

Then, in step S1318, a determination is made whether the stack pointer for search path stack 310 points to the array element number of the root node. if it points to the array element number of the root node, processing proceeds to step S1324, and if it does not point to the array element number of the root node, processing proceeds to step S1319.

At step S1319, the stack pointer for search path stack 310 is decremented by 1 and the array element number stored therein is extracted. Next, proceeding to step S1320, the array element with the array element number extracted at step S1319 is read out from the array as a node. Next, proceeding to step S1321, the discrimination bit position is extracted from the node read out at step S1320.

Then, proceeding to step S1322, wherein a determination is made whether the discrimination bit position extracted at step S1321 has a higher position relationship than the bit position obtained at step S1317. If the result of the determination at step S1322 is “no”, processing returns to step S1318, and the processing loop of step S1318 to step S1322 is repeated until the result of the determination at step S1318 becomes “yes” or the result of the determination at step S1322 becomes “yes”. When the result of the determination at step S1322 becomes “yes”, at step S1323, the stack pointer for the search path stack is incremented by 1, and processing moves to the processing in step S1324 and thereafter.

This processing loop of step S1316 to step S1322 is the processing to check the relative position relationship between the bit position of the first differing bit in the difference bit string and the discrimination bit position in a branch node stored in the array element with the array element number stored in search path stack 310, and to decide the insertion position, in the coupled-node tree, for the node pair to be inserted, by successively traversing the search path stack in reverse until the discrimination bit position becomes the higher position.

In step S1324, the array element number pointed to by the stack pointer is extracted from search path stack 310. Then, in step S1325, a “1” (leaf node) is written in the node type of the array element pointed to by the array element number obtained at step S1314 and the pointer pointing to the storage area wherein the insertion key is stored is written into the reference pointer. In this way, the reference pointer pointing to the insertion code string is written into the leaf node.

Next, proceeding to step S1326, the array element with the array element number obtained from the array at step S1324 is read out. Continuing, in step S1327, the contents read out at step S1326 are written into the array element with the array element number obtained at step S1315.

Finally, in step S1328, a “0” (branch node) is written into the node type of the array element pointed to by the array element number obtained at step S1324, the bit position obtained at step S1317 is written into the discrimination bit position, the array element number obtained at step S1312 is written into the coupled node indicator, and processing is terminated.

In this way, by the processing in step S1324 and thereafter, data is set in each node and insertion processing is completed.

Next, referencing FIG. 14A to FIG. 14B, the processing to delete a leaf node from a coupled-node tree related to one preferred embodiment of this invention, in accordance with the specification of a deletion key, is described. This deletion processing is similar to that disclosed in Patent Document 2 with the exception that the deletion key and the search target code strings are encoded.

FIG. 14A is a drawing describing an example of the processing flow for the prior stage of deletion processing in one embodiment of the present invention.

First, at step S1401, the code string (deletion key) to be deleted from the coupled-node tree is set in the deletion code string. Next, at step S1402, the deletion code string is encoded and an encoded deletion key is generated. The encode processing in step S1402 can be implemented by the processing flow shown in FIG. 7.

Next, in step S1403, the array element number of the root node is set in the array element number of the search start node, and at step S1404, the encoded deletion key is set in the encoded search key, and processing proceeds to step S1405. At step S1405, the array is searched from the search start node using the encoded search key, and a reference pointer is obtained. This processing is implemented using the basic search processing shown in FIG. 5.

Next, proceeding to step S1406, the code string pointed to by the reference pointer obtained in step S1405 is read out from code string storage area 311. Then, at step S1407, an encoded code string (index key) is generated from the code string read out at step S1406. The encode processing in step S1407 can be implemented by the processing flow shown in FIG. 7.

Then, at step S1408, the encoded deletion key set at step S1404 is compared with the index key generated at step S1407, and if they do not coincide the deletion fails because a leaf node related to a search target code string that corresponds to the deletion key does not exist in the coupled-node tree and processing is terminated. If they do coincide, processing proceeds to the processing of step S1412 in FIG. 14B and thereafter.

FIG. 14B is a drawing describing an example of the processing flow for the latter stage of deletion processing in one embodiment of the present invention. As shown in the drawing, in step S1412, a determination is made whether 2 or more array element numbers are stored in search path stack 310.

When the result of that determination is “no”, there is only one array element number stored and that array element number is the one for the array element wherein the root node is stored. In this case, processing proceeds to step S1418, and the node pair related to the array element number of the root node set at step S1403 is deleted. Then, proceeding to step S1419, the array element number of the root node registered in the management means for the coupled-node tree is deleted and processing is terminated.

Conversely, when the determination in step S1412 is that 2 or more array element numbers are stored in search path stack 310, processing proceeds to step S1413, and the bit value obtained at step S507 in FIG. 5 is inverted and added to the coupled node indicator obtained at step S508 in FIG. 5 called at step S1405, and an array element number is obtained. This processing is the processing to obtain the array element number of the array element wherein is stored the node that is the other pair to the leaf node holding the reference pointer pointing to the storage area holding the deletion key.

Next, in step S1414, the contents of the array element with the array element number obtained at step S1413 are read out from the array, and in step S1415, the stack pointer for the search path stack is decremented by 1 and the array element number is extracted.

Next, proceeding to step S1416, the contents of the array element read out at step S1414 are written over the contents in the array element with the array element number obtained at step S1415. This processing is the processing to replace the branch node that is the link source for the leaf node holding the reference pointer pointing to the area wherein is stored the deletion key with the node that is the pair to the leaf node.

Finally, in step S1417, the node pair pointed to by the coupled node indicator obtained at step S508 in FIG. 5 called at step S1405 are deleted, and deletion processing is terminated.

As was described above, in this invention, the advantages of a coupled-node tree continue to be kept such that the range of existing nodes that are affected by the insertion processing and deletion processing noted above is minimal and the maintenance cost for inserting and deleting is low. Also these advantages can continue to be kept by using the above noted encoding method, and a high-speed longest prefix match search is enabled.

Hereinabove was described the processing flows for realizing a code string search method related to a preferred embodiment of this invention. It is clear that these processing flows can be placed in programs executed in a computer like the processing apparatus 301 exemplified in FIG. 4 and a bit string search apparatus related to this invention can be constructed on a computer. And so, a functional configuration of a code string search apparatus related to this invention is described hereinbelow.

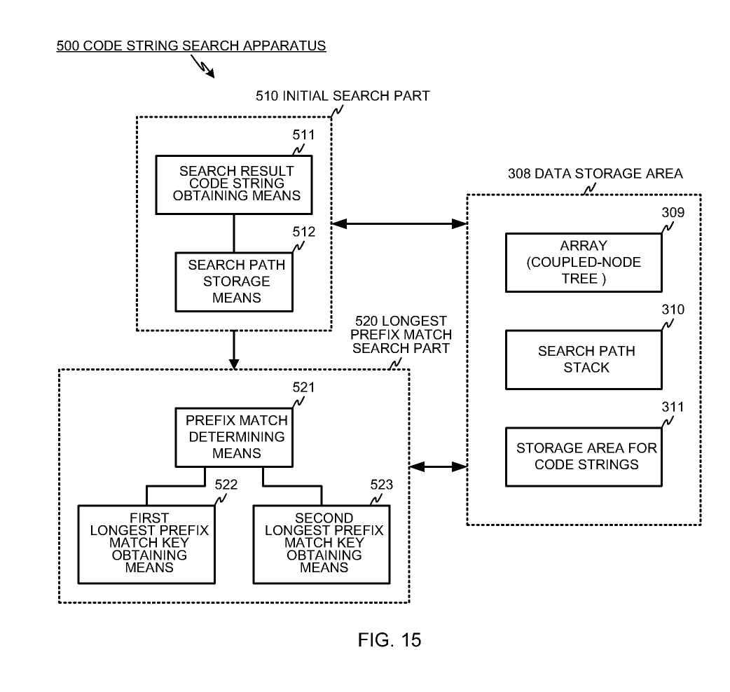

FIG. 15 is a drawing showing an example of a function block configuration for a code string search apparatus in one embodiment of the present invention.

As shown in FIG. 15 the code string search apparatus 500 includes the initial search part 510 and the longest prefix match search part 520 realized in the data processing apparatus 301 exemplified in FIG. 4, and the data storage apparatus 308 arranged for the array 309, wherein is disposed the coupled-node tree 200, the search path stack 310, and the code string storage area 311.

The initial search part 510 prepares the search result code string obtaining means 511 and the search path storage means 512. The longest prefix match search part 520 prepares the prefix match determination means 521, the first longest prefix matching key obtaining means 522, and the second longest prefix matching key obtaining means 523.

The functions of the initial search part 510 are implemented by step S605 in FIG. 6, in other words, implemented by the initial search processing exemplified in FIG. 8B and the first-time processing of step S901 shown in FIG. 9B. Also, the functions of the longest prefix match search part 520 are implemented by the longest prefix match search processing exemplified in FIG. 9B to FIG. 9D.

Also, although, in the preferred embodiment described hereinabove, as shown in FIG. 9A, the search path stack 310 is divided into two columns and is configured such that a group consisting of 2 array element numbers, one being the array element number of the code string delimiter branch node and the other being the array element number for the node [1] among the child nodes of the code string delimiter branch node, and both are stored in the storage place specified by a single value in the stack pointer, this method is not restricted to such a configuration.

It is also allowed that the search path stack 310 wherein is stored the array element numbers of code string delimiter branch nodes and the array element numbers of child nodes may be divided into an area wherein is stored the array element numbers of code string delimiter branch nodes and an area wherein is stored the array element numbers of child nodes, and in the storage processing a stack pointer for each may be operated on and storing done, and in the extraction processing the stack pointers may be synchronized and the extraction done. For example, in step S813 and S815 in FIG. 8B, both of the stack pointers for the array element numbers for the code string delimiter branch nodes and the array element numbers for the child nodes can be operated on and the array element numbers stored in each stack respectively, and also, in the processing shown in FIG. 9B to FIG. 9D, it is sufficient to synchronize the operations of each of the stack pointers.

Also, although, in the preferred embodiment noted above, the leaf nodes in the coupled-node tree are made to include a search target code string or a reference pointer pointing to a storage area wherein is stored the search target code string and the search result code string is encoded in the bit string comparison with the encoded search key, it is also allowed to encode the search target code string from the very beginning, and to directly obtain the index key that is the encoded code string as the search result. Which of those methods are used should be decided by considering the storage capacity needed for the search target code string and the processing cost needed for the encoding during the search.

What is claimed is:

1. A code string search apparatus that searches for search target code strings based on a tree data configuration by means of an encoded search key which is a bit string that encodes a search key consisting of code strings, comprising:
a coupled-node tree having a root node that is the starting point for the tree and node pairs which are two nodes, a primary node and a non-primary node, located in adjacent storage areas, as configurational elements of the tree, wherein
the nodes have an area holding a node type which expresses whether the node is a branch node or a leaf node, and
the branch node, in addition to the node type, includes an area holding a discrimination bit position for the encoded search key and an area holding information expressing the position of a primary node of a node pair that is a link target, and
the leaf node, in addition to the node type, includes an area holding a search target code string or a reference pointer that points to a storage area for the search target code string,
the tree data configuration being prescribed by the bit values for index keys that are bit strings encoding search target code strings;
an initial search part that searches, by means of the encoded search key, the search target code strings based on the tree data configuration of the coupled-node tree and
obtains a search result code string in an initial search while memorizing the path in the coupled-node tree traversed in the initial search;
a longest prefix match search part that
obtains, as the longest prefix matching key, the longest search target code string that prefix-matches the search key from
the search result code string obtained in the initial search and
the search target code strings
included in the leaf nodes existing on the memorized path over the coupled-node tree or
stored in an areas pointed to by the reference pointers included in the leaf nodes existing on the memorized path over the coupled-node tree; and
wherein
the encoding of a search key consisting of code strings and the search target code strings is one wherein
at the head of the bit string expressing each code configuring each of those code strings is appended
a continue bit, which is a differentiating bit expressing the fact that a code is following, and
an end bit, which is a differentiating bit expressing the end of the code string.

2. A code string search apparatus according to claim 1, wherein
the initial search part includes
a search result code string obtaining means that taking the root node as the search start node,
repeats the process of
reading out from a branch node the information of its discrimination bit position and information expressing the position of the primary node of the node pair that is its link target and
obtaining information on a node position by a computation using the bit value at the read-out discrimination bit position in the encoded search key and the information expressing the read-out position of the primary node, and reading out the node at the obtained position as a link target node
until the node type of the read-out link target node is a leaf node, and
obtains the search target code string included in the leaf node that is reached as the search result code string for the initial search or
obtains the reference pointer included in the leaf node that is reached and obtains the search target code string stored in the storage area pointed to by the reference pointer as the search result code string for the initial search, and
a search path storage means that
memorizes the path in the coupled-node tree traversed during the initial search by storing in a stack
information expressing the position of a code string delimiter branch node, which is a branch node wherein, of the branch nodes passed in reaching the leaf node, the value of its discrimination bit position coincides with one of the positions wherein exists a differentiating bit, and
information for computing the position of a code string terminus node, which is a node containing information for accessing the search target code string related to that code string terminus node and for which, of the node pair that is the link target of that code string delimiter branch node, the value at its discrimination bit position is the value of the end bit, and
the longest prefix match search part includes
a prefix match determining means that determines whether the index key that encodes the search result code string for the initial search prefix-matches the encoded search key and
a first longest prefix matching key obtaining means that,
if the determination is that the index key that encodes the search result code string for the initial search prefix-matches the encoded search key,
obtains the search target code string as the longest prefix matching key, and
a second longest prefix matching key obtaining means that,
if the determination is that the index key that encodes the search result code string for the initial search does not prefix-match the encoded search key,
successively extracts from the stack, in sequence from the last stored, information for accessing the search target code strings related to the code string terminus nodes, and
compares the bit strings between the first index keys for which the bit length of the index key encoding the search target code string accessed by means of the extracted information is equal to or less than the bit length of encoded search key within the range up to but not including its end bit and the encoded search key within the range up to but not including its end bit and
obtains the bit position of the first bit, seen from the highest level, whose bit value differs, and
also successively extracts from the stack information expressing the position of code string delimiter branch nodes, and the first time the discrimination bit position in a code string delimiter branch node in the position that the extracted information expresses is a higher position than the difference bit position, extracts from the code string terminus node, which is a node of the node pair that is the link target of the code delimiter branch node, information for accessing the search target code string related to the code string terminus node, and
obtains, as the longest prefix matching key, a search target code string accessed based on the extracted information.

3. A code string search apparatus according to claim 2, wherein
the coupled-node tree is disposed in an array, and
the information expressing the position of the primary node and
the information expressing the position of the code string delimiter branch node are the array element numbers of array elements in the array wherein their respective nodes are stored.

4. A code string search apparatus according to claim 3, wherein
the information for accessing a search target code string related to a code string terminus node is either
the array element number of the array element in the array wherein is stored the code string terminus node
or
the array element number of the array element in the array wherein is stored the node that is a pair to the code string terminus node.

5. A code string search apparatus according to claim 2, wherein
the information for accessing the search target code string related to the code string terminus node is either
the search target code string related to the code string terminus node
or
a reference pointer pointing to a storage area wherein is stored the search target code string related to the code string terminus node.

6. A code string search method wherein the code string search apparatus according to claim 1 searches search target code strings, comprising:
an initial search step that
searches, by means of the encoded search key, the search target code strings based on the tree data configuration of the coupled-node tree and
obtains a search result code string in an initial search while memorizing the path in the coupled-node tree traversed in the initial search; and
a longest prefix match search step that
obtains, as the longest prefix matching key, the longest search target code string that prefix-matches the search key from
the search result code string obtained in the initial search and
the search target code strings
included in the leaf nodes existing on the memorized path over the coupled-node tree or
stored in an areas pointed to by the reference pointers included in the leaf nodes existing on the memorized path over the coupled-node tree.

7. A code string search method according to according to claim 6, wherein
the initial search step includes
a search result code string obtaining step that taking the root node as the search start node,
repeats the process of
reading out from a branch node the information of its discrimination bit position and information expressing the position of the primary node of the node pair that is its link target and
obtaining information on a node position by a computation using the bit value at the read-out discrimination bit position in the encoded search key and the information expressing the read-out position of the primary node, and reading out the node at the obtained position as a link target node
until the node type of the read-out link target node is a leaf node, and
obtains the search target code string included in the leaf node that is reached as the search result code string for the initial search or
obtains the reference pointer included in the leaf node that is reached and obtains the search target code string stored in the storage area pointed to by the reference pointer as the search result code string for the initial search, and
a search path storage step that
memorizes the path in the coupled-node tree traversed during the initial search by storing in a stack
information expressing the position of a code string delimiter branch node, which is a branch node wherein, of the branch nodes passed in reaching the leaf node, the value of its discrimination bit position coincides with one of the positions wherein exists a differentiating bit, and
information for computing the position of a code string terminus node, which is a node containing information for accessing the search target code string related to that code string terminus node and for which, of the node pair that is the link target of that code string delimiter branch node, the value at its discrimination bit position is the value of the end bit, and
the longest prefix match search step includes
a prefix match determining step that determines whether the index key that encodes the search result code string for the initial search prefix-matches the encoded search key and
a first longest prefix matching key obtaining step that,
if the determination is that the index key that encodes the search result code string for the initial search prefix-matches the encoded search key,
obtains the search target code string as the longest prefix matching key, and
a second longest prefix matching key obtaining step that,
if the determination is that the index key that encodes the search result code string for the initial search does not prefix-match the encoded search key,
successively extracts from the stack, in sequence from the last stored, information for accessing the search target code strings related to the code string terminus nodes, and
compares the bit strings between the first index keys for which the bit length of the index key encoding the search target code string accessed by means of the extracted information is equal to or less than the bit length of encoded search key within the range up to but not including its end bit and the encoded search key within the range up to but not including its end bit and
obtains the bit position of the first bit, seen from the highest level, whose bit value differs, and
also successively extracts from the stack information expressing the position of code string delimiter branch nodes, and the first time the discrimination bit position in a code string delimiter branch node in the position that the extracted information expresses is a higher position than the difference bit position, extracts from the code string terminus node, which is a node of the node pair that is the link target of the code delimiter branch node, information for accessing the search target code string related to the code string terminus node, and
obtains, as the longest prefix matching key, a search target code string accessed based on the extracted information.

8. A code string search method according to claim 7, wherein
the coupled-node tree is disposed in an array, and
the information expressing the position of the primary node and
the information expressing the position of the code string delimiter branch node are the array element numbers of array elements in the array wherein their respective nodes are stored.

9. A code string search method according to claim 8, wherein
the information for accessing a search target code string related to a code string terminus node is either
the array element number of the array element in the array wherein is stored the code string terminus node
or
the array element number of the array element in the array wherein is stored the node that is a pair to the code string terminus node.

10. A code string search method according to claim 7, wherein
the information for accessing the search target code string related to the code string terminus node is either
the search target code string related to the code string terminus node
or
a reference pointer pointing to a storage area wherein is stored the search target code string related to the code string terminus node.

11. A program that a computer is caused to execute, for performing the code string search method according to claim 6.

12. A computer readable storage medium containing the program according to claim 11.

13. A tree data configuration for a code string search method for searching search target code strings that are bit strings encoding search keys consisting of code strings, comprising:
a coupled-node tree having a root node that is the starting point for the tree and node pairs which are two nodes, a primary node and a non-primary node, located in adjacent storage areas, as configurational elements of the tree, wherein
the nodes have an area holding a node type which expresses whether the node is a branch node or a leaf node, and
the branch node, in addition to the node type, includes an area holding a discrimination bit position for the encoded search key and an area holding information expressing the position of a primary node of a node pair that is a link target, and
the leaf node, in addition to the node type, includes an area holding a search target code string or a reference pointer that points to a storage area for the search target code string,
the tree data configuration being prescribed by the bit values for index keys that are bit strings encoding search target code strings and
the encoding of a search key consisting of code strings and the search target code strings being one wherein
at the head of the bit string expressing each code configuring each of those code strings is appended
a continue bit, which is a differentiating bit expressing the fact that a code is following, and
an end bit, which is a differentiating bit expressing the end of the code string; and
wherein
a search method by means of the search key is enabled such that
an initial search step that
searches, by means of the encoded search key, the search target code strings based on the tree data configuration of the coupled-node tree and
obtains a search result code string in an initial search while memorizing the path in the coupled-node tree traversed in the initial search and
a longest prefix match search step that
obtains, as the longest prefix matching key, the longest search target code string that prefix-matches the search key from
the search result code string obtained in the initial search and
the search target code strings
included in the leaf nodes existing on the memorized path over the coupled-node tree or
stored in an areas pointed to by the reference pointers included in the leaf nodes existing on the memorized path over the coupled-node tree.

14. A tree data configuration according to claim 13, wherein
the initial search step includes
a search result code string obtaining step that taking the root node as the search start node,
repeats the process of
reading out from a branch node the information of its discrimination bit position and information expressing the position of the primary node of the node pair that is its link target and
obtaining information on a node position by a computation using the bit value at the read-out discrimination bit position in the encoded search key and the information expressing the read-out position of the primary node, and reading out the node at the obtained position as a link target node
until the node type of the read-out link target node is a leaf node, and
obtains the search target code string included in the leaf node that is reached as the search result code string for the initial search or
obtains the reference pointer included in the leaf node that is reached and obtains the search target code string stored in the storage area pointed to by the reference pointer as the search result code string for the initial search, and
a search path storage step that
memorizes the path in the coupled-node tree traversed during the initial search by storing in a stack
information expressing the position of a code string delimiter branch node, which is a branch node wherein, of the branch nodes passed in reaching the leaf node, the value of its discrimination bit position coincides with one of the positions wherein exists a differentiating bit, and
information for computing the position of a code string terminus node, which is a node containing information for accessing the search target code string related to that code string terminus node and for which, of the node pair that is the link target of that code string delimiter branch node, the value at its discrimination bit position is the value of the end bit, and
the longest prefix match search step includes
a prefix match determining step that determines whether the index key that encodes the search result code string for the initial search prefix-matches the encoded search key and
a first longest prefix matching key obtaining step that,
if the determination is that the index key that encodes the search result code string for the initial search prefix-matches the encoded search key,
obtains the search target code string as the longest prefix matching key, and
a second longest prefix matching key obtaining step that,
if the determination is that the index key that encodes the search result code string for the initial search does not prefix-match the encoded search key,
successively extracts from the stack, in sequence from the last stored, information for accessing the search target code strings related to the code string terminus nodes, and
compares the bit strings between the first index keys for which the bit length of the index key encoding the search target code string accessed by means of the extracted information is equal to or less than the bit length of encoded search key within the range up to but not including its end bit and the encoded search key within the range up to but not including its end bit and
obtains the bit position of the first bit, seen from the highest level, whose bit value differs, and
also successively extracts from the stack information expressing the position of code string delimiter branch nodes, and the first time the discrimination bit position in a code string delimiter branch node in the position that the extracted information expresses is a higher position than the difference bit position, extracts from the code string terminus node, which is a node of the node pair that is the link target of the code delimiter branch node, information for accessing the search target code string related to the code string terminus node, and
obtains, as the longest prefix matching key, a search target code string accessed based on the extracted information.

15. A tree data configuration according to claim 14, wherein
the coupled-node tree is disposed in an array, and
the information expressing the position of the primary node and
the information expressing the position of the code string delimiter branch node are the array element numbers of array elements in the array wherein their respective nodes are stored.

16. A tree data configuration for a code string search method according to claim 15, wherein
the information for accessing the search target code string related to the code string terminus node is either
the array element number of the array element in the array wherein is stored the code string terminus node
or
the array element number of the array element in the array wherein is stored the node that is a pair to the code string terminus node.

17. A tree data configuration according to claim 14, wherein
the information for accessing the search target code string related to the code string terminus node is either
the search target code string related to the code string terminus node
or
a reference pointer pointing to a storage area wherein is stored the search target code string related to the code string terminus node.

18. A computer readable storage medium containing data with the tree data configuration according to claim 13.
